(19) United States
(12) Patent Application Publication
(10) Pub. No.: US 2026/0342016 A1
(43) Pub. Date: Oct. 29, 2026

(54) CONNECTOR AND CONNECTOR ASSEMBLY WITH ADAPTER MODULE

(71) Applicant: DONGGUAN LUXSHARE TECHNOLOGIES CO., LTD, Dongguan City (CN)

(72) Inventors: Bin HUANG, Dongguan City (CN); Kunlin YAO, Dongguan City (CN); Jie ZHANG, Dongguan City (CN); Hongji CHEN, Dongguan City (CN); Chenhui ZENG, Dongguan City (CN); Shuangfeng YUAN, Dongguan City (CN)

(73) Assignee: DONGGUAN LUXSHARE TECHNOLOGIES CO., LTD, Dongguan City (CN)

(21) Appl. No.: 19/650,801

(22) Filed: Apr. 17, 2026

(30) Foreign Application Priority Data
Apr. 25, 2025 (CN) 202510535601.0

(51) Int. Cl. H01R 13/6581

(52) U.S. Cl. CPC H01R 13/6581

(57) ABSTRACT

A connector includes a shielding cage and an adapter module. The shielding cage includes an accommodating cavity and a receiving cavity. The adapter module is at least partially disposed in the shielding cage. The adapter module includes a number of adapter terminals. The adapter terminal includes a contact surface and a mounting tail portion configured to be electrically connected to a circuit board. A connector assembly having the connector is also disclosed.

### CROSS-REFERENCE TO RELATED APPLICATION

This patent application claims priority of a Chinese Patent Application No. 202510535601.0, filed on Apr. 25, 2025 and titled “ELECTRICAL CONNECTOR AND CONNECTOR ASSEMBLY”, the entire content of which is incorporated herein by reference.

### TECHNICAL FIELD

The present disclosure relates to an electrical connector and a connector assembly, which belongs to the field of connector technology.

### BACKGROUND

A connector assembly in the related art includes an electrical connector, a shielding cage and a circuit board. The electrical connector includes an insulating body, a plurality of conductive terminals mounted to the insulating body, and a cable connected to the conductive terminals. The conductive terminals include high-speed signal terminals and non-high-speed signal terminals.

As the electrical connector continuously improves its signal transmission requirement, the cable is used in related technologies to transmit high-speed signals. In the meanwhile, the non-high-speed signal terminals are often mounted to the circuit board.

The non-high-speed signal terminals in the related art are usually provided with elastic abutting arms. The elastic abutting arms are in elastic contact with the conductive pads of the circuit board. In order to improve the electrical properties of the elastic abutting arms and the conductive pads, it is often necessary to gold plate at least partial areas of the circuit board, which greatly increases the complexity of the circuit board.

Therefore, there is still room for improvement for the connector assembly in the related art.

### SUMMARY

An embodiment of the present disclosure adopts the following technical solution: a connector, including: a shielding cage, the shielding cage including a first end face, a second end face disposed opposite to the first end face, an accommodating cavity extending through the first end face along a first direction, and a receiving cavity extending through the second end face along the first direction; the accommodating cavity being configured to accommodate a mating connector along the first direction; the receiving cavity is configured to accommodate an electrical connector along the first direction; the electrical connector being configured to mate with the mating connector; and an adapter module, the adapter module being at least partially disposed in the shielding cage; the adapter module including an adapter block, the adapter block including a plurality of adapter terminals and an insulating retention block fixed with the adapter terminals; each adapter terminal including a contact surface exposed from the insulating retention block and located in the receiving cavity, and a mounting tail configured to be electrically connected to a circuit board.

An embodiment of the present disclosure adopts the following technical solution: a connector assembly, including: a connector including: a shielding cage, the shielding cage including a first end face, a second end face disposed opposite to the first end face, an accommodating cavity extending through the first end face along a first direction, and a receiving cavity extending through the second end face along the first direction; the accommodating cavity being configured to accommodate a mating connector along the first direction; and an adapter module, the adapter module being at least partially disposed in the shielding cage; the adapter module including an adapter block, the adapter block including a plurality of adapter terminals and an insulating retention block fixed with the adapter terminals; each adapter terminal including a contact surface exposed from the insulating retention block and located in the receiving cavity, and a mounting tail configured to be electrically connected to a circuit board; and an electrical connector, the receiving cavity being configured to accommodate the electrical connector along the first direction; the electrical connector being configured to mate with the mating connector; the electrical connector including a plurality of conductive terminals, a cable electrically connected to the conductive terminals, and a plurality of board-end terminals; each board-end terminal including an elastic contact portion; wherein the electrical connector is at least partially inserted in the receiving cavity along the first direction, such that the elastic contact portions abut against the contact surfaces.

### BRIEF DESCRIPTION OF DRAWINGS

FIG. 1 is a partially exploded view of a connector assembly in accordance with an embodiment of the present disclosure, wherein a first mating connector and a second mating connector are not inserted into a shielding cage;

FIG. 2 is a perspective schematic view of the connector assembly in accordance with another embodiment of the present disclosure;

FIG. 3 is a perspective view of FIG. 2 from another angle;

FIG. 4 is a perspective view of FIG. 3 from another angle;

FIG. 5 is a front view of FIG. 2;

FIG. 6 is a partially exploded view of FIG. 2;

FIG. 7 is a partially exploded view of FIG. 6 from another angle;

FIG. 8 is a partially exploded view of FIG. 7 from another angle;

FIG. 9 is a partial enlarged view of circle part B in FIG. 8;

FIG. 10 is a partially perspective exploded view of FIG. 6;

FIG. 11 is a partially exploded view of FIG. 10 from another angle;

FIG. 12 is a partially exploded view of FIG. 11 from another angle;

FIG. 13 is a further partially exploded view after removing a first electrical connector and a second electrical connector in FIG. 10, wherein an adapter module is separated;

FIG. 14 is a partially exploded view of FIG. 13 from another angle;

FIG. 15 is a perspective exploded view of the shielding cage in FIG. 13;

FIG. 16 is a perspective exploded view of FIG. 15 from another angle;

FIG. 17 is a front view of the adapter module in FIG. 13;

FIG. 18 is a rear view of the adapter module in FIG. 13;

FIG. 19 is a partially exploded view of the adapter module in FIG. 13;

FIG. 20 is a partially exploded view of FIG. 19 from another angle;

FIG. 21 is a perspective exploded view of a first adapter terminal module and a second adapter terminal module in FIG. 19;

FIG. 22 is a perspective exploded view of a third adapter terminal module, a fourth adapter terminal module and a support block in FIG. 19;

FIG. 23 is a perspective exploded view of FIG. 22 from another angle;

FIG. 24 is a right view of the first electrical connector in FIG. 10;

FIG. 25 is a perspective schematic view of the first electrical connector from another angle;

FIG. 26 is a partially perspective exploded view of the first electrical connector in FIG. 10;

FIG. 27 is a partially exploded view of FIG. 26;

FIG. 28 is a partially exploded view of FIG. 27 from another angle;

FIG. 29 is a top view of a first module and a second module when they are assembled together;

FIG. 30 is a top view after the first module and the second module in FIG. 29 are separated;

FIG. 31 is a bottom view after the first module and the second module in FIG. 29 are separated;

FIG. 32 is a partially exploded view of the first module in FIG. 27;

FIG. 33 is a partially exploded view of the second module in FIG. 27;

FIG. 34 is a partially exploded view of FIG. 32 from another angle;

FIG. 35 is a partially exploded view of FIG. 33 from another angle;

FIG. 36 is a cross-sectional view taken along line E-E in FIG. 5;

FIG. 37 is a partial enlarged view of frame part C in FIG. 36;

FIG. 38 is a partial enlarged view of frame part D in FIG. 36;

FIG. 39 is a perspective schematic view of the connector assembly in accordance with another embodiment of the present disclosure;

FIG. 40 is a perspective schematic view of FIG. 39 from another angle;

FIG. 41 is a partially exploded view of FIG. 39;

FIG. 42 is a partially exploded view of FIG. 41 from another angle;

FIG. 43 is a further partially exploded view after removing a circuit board in FIG. 41 and a plurality of second mating connectors, wherein the adapter module is separated;

FIG. 44 is a partially exploded view of FIG. 43 from another angle;

FIG. 45 is a perspective exploded view of the adapter module in FIG. 43;

FIG. 46 is a perspective exploded view of FIG. 45 from another angle;

FIG. 47 is a perspective exploded view of an adapter block of the adapter module in FIG. 45;

FIG. 48 is a perspective exploded view of FIG. 47 from another angle;

FIG. 49 is a cross-sectional view taken along line F-F in FIG. 39;

FIG. 50 is a partial enlarged view of frame part H in FIG. 49;

FIG. 51 is a cross-sectional view taken along line J-J in FIG. 39;

FIG. 52 is a partial enlarged view of frame part K in FIG. 51, wherein spring tabs are in a locked position; and

FIG. 53 is a schematic view of another state of FIG. 52, wherein the spring tabs are in an unlocked position.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

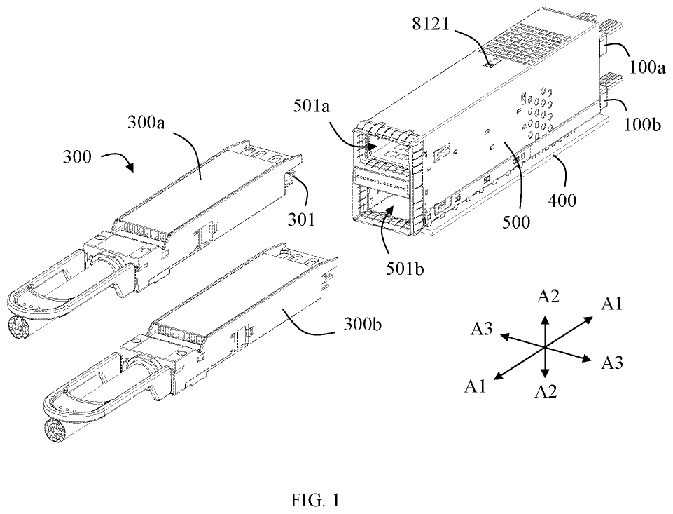

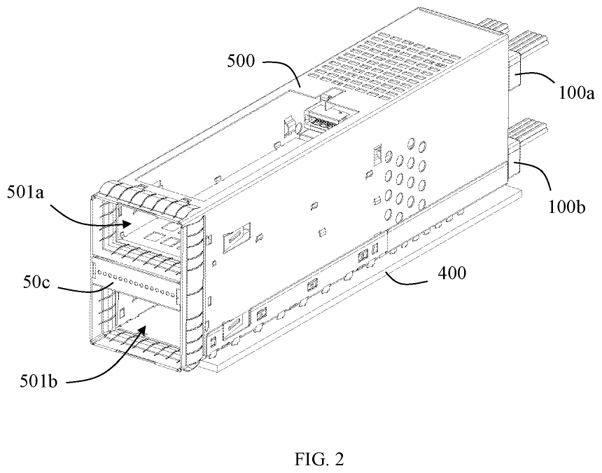

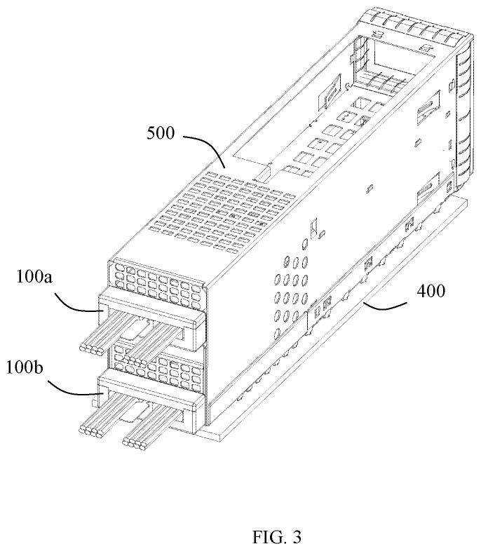

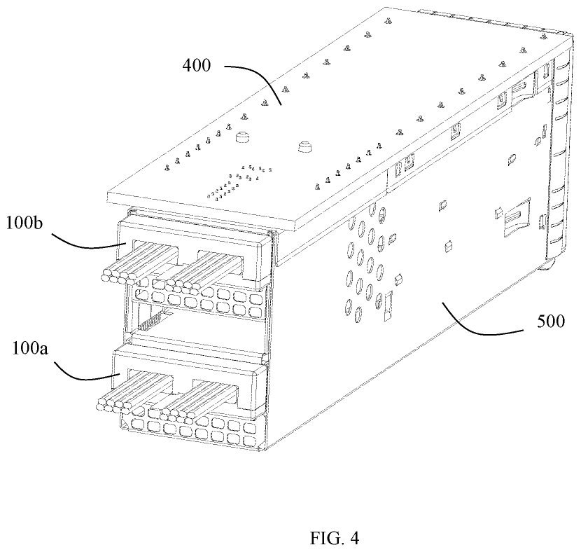

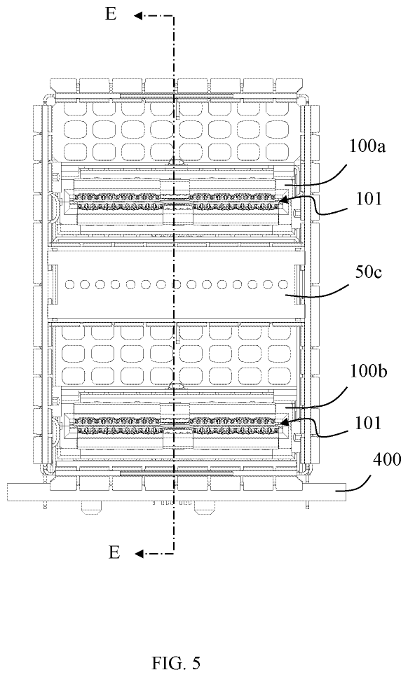

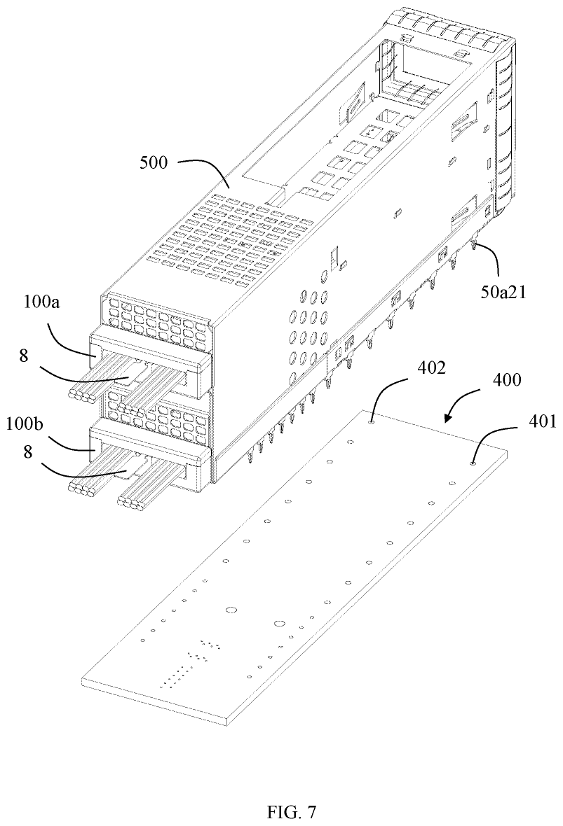

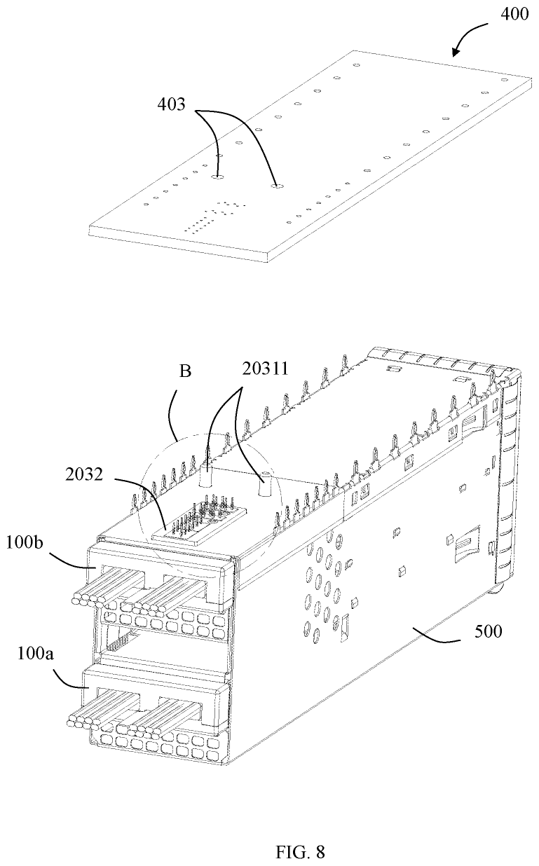

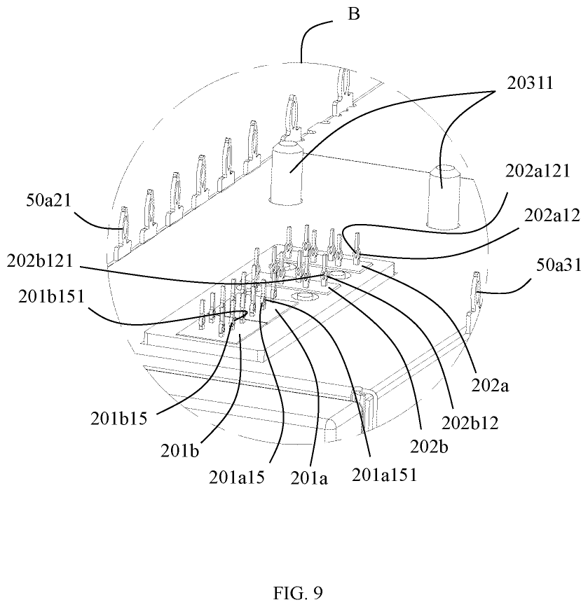

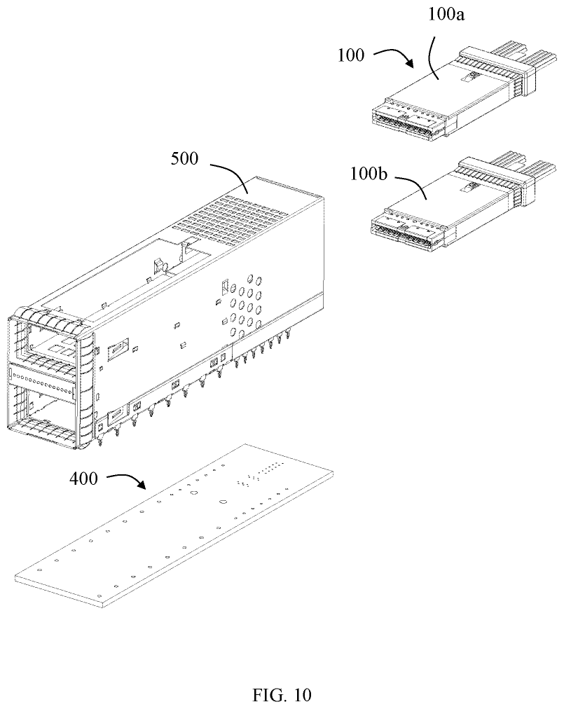

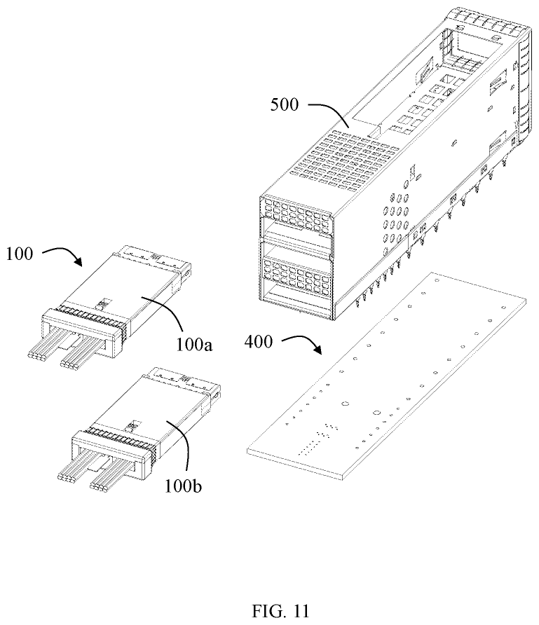

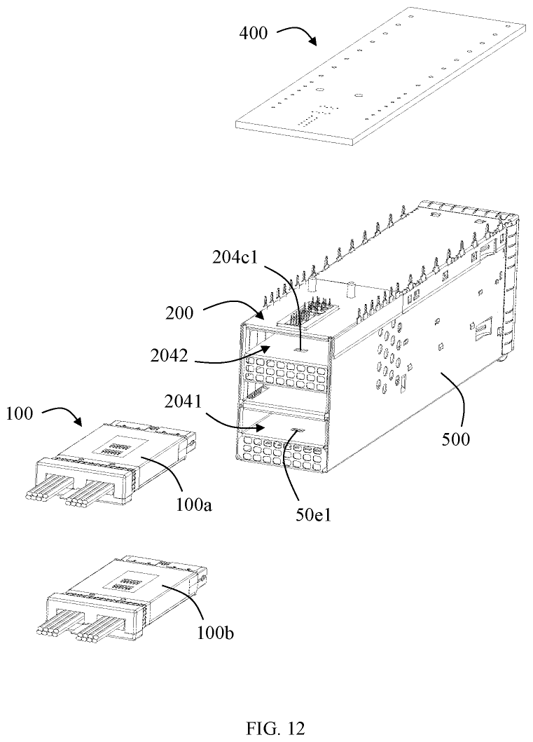

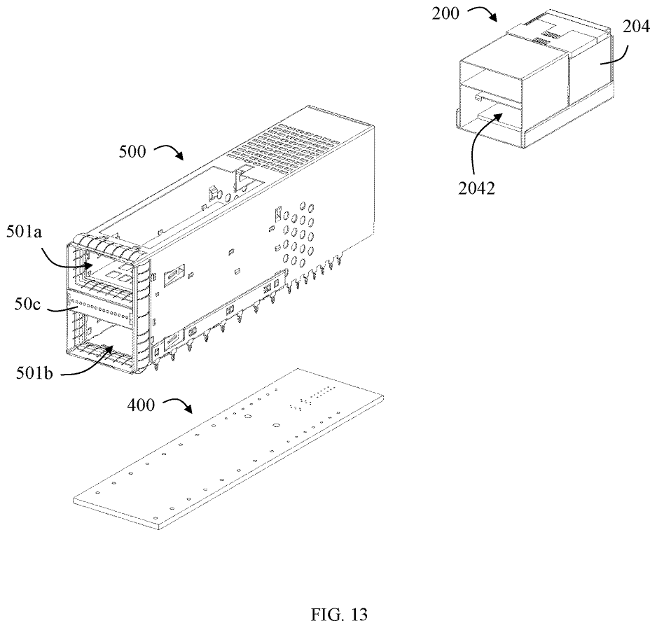

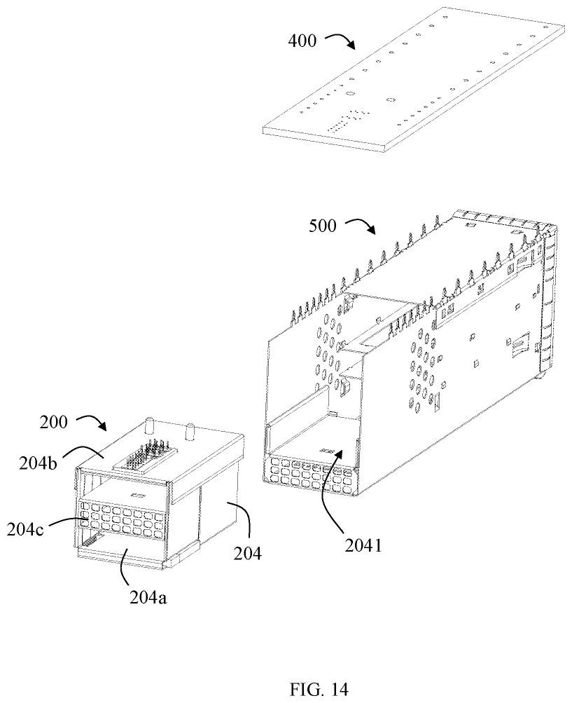

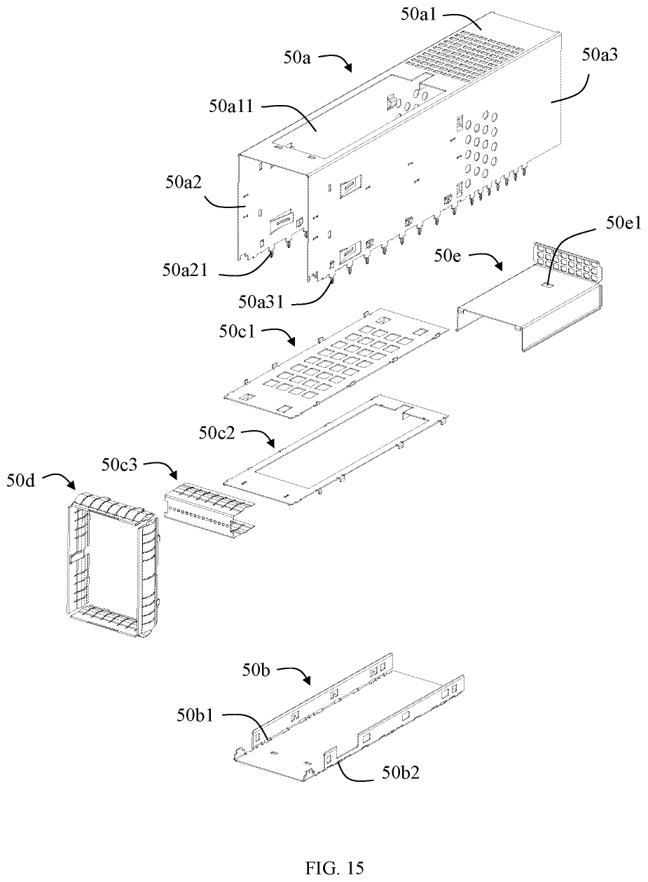

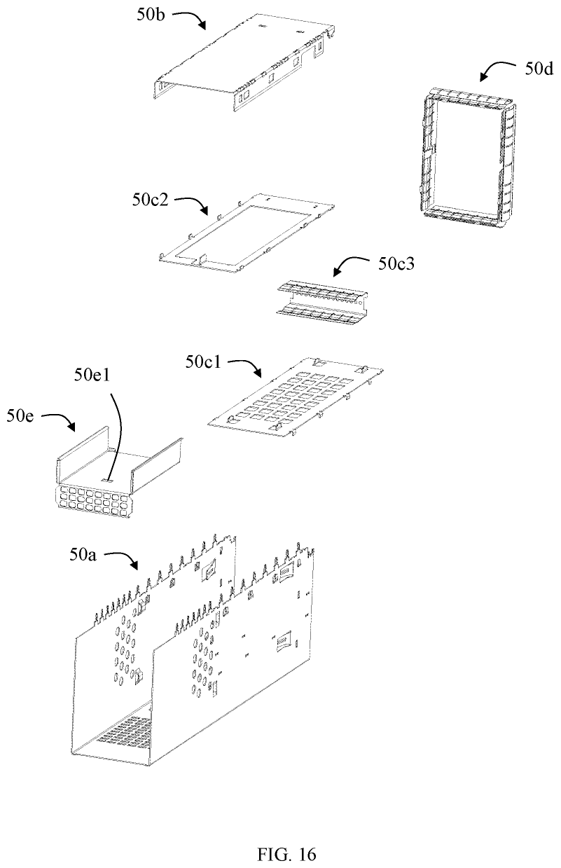

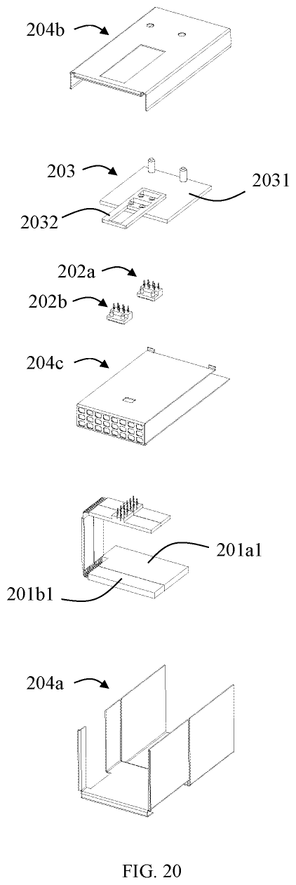

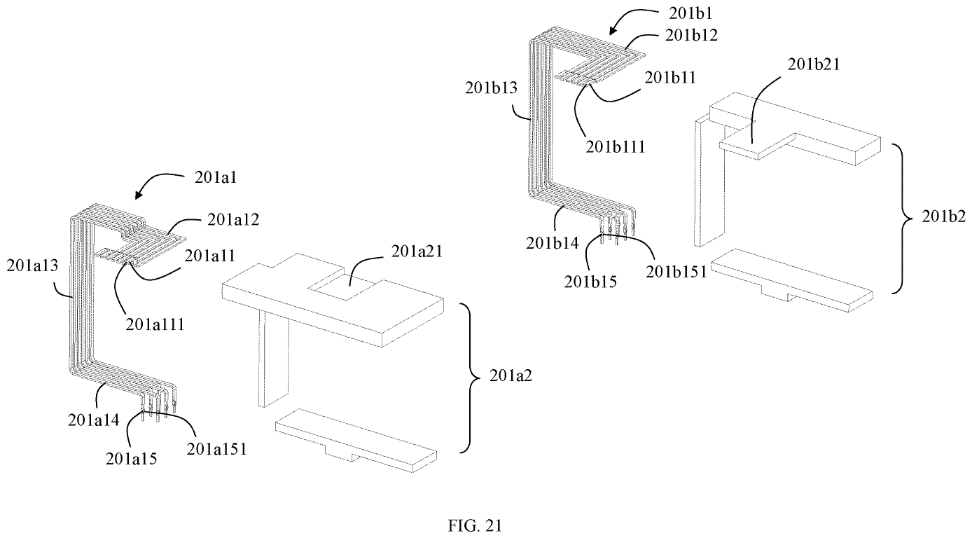

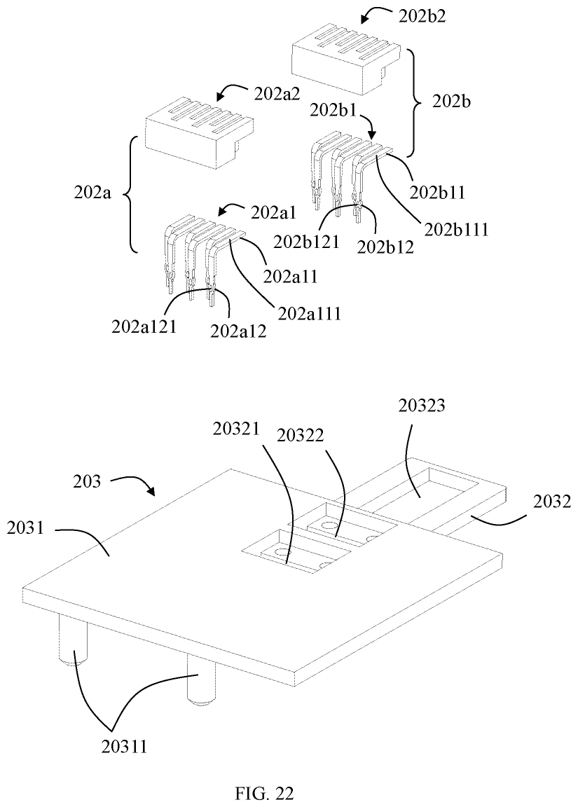

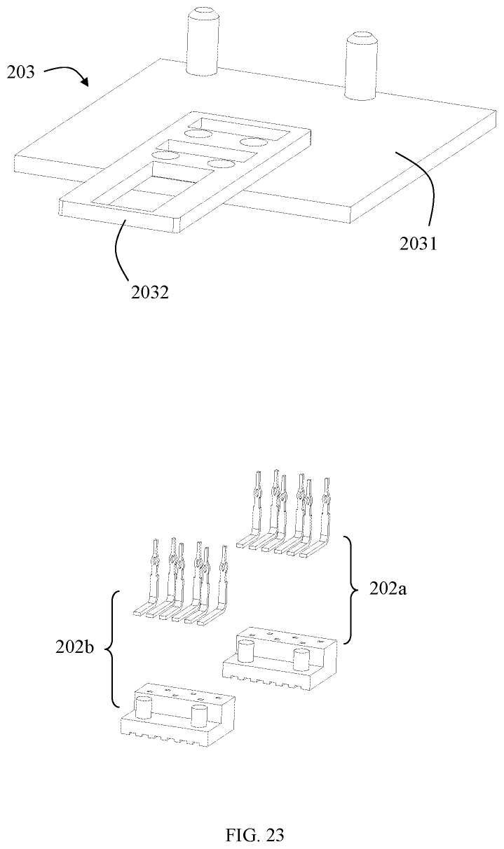

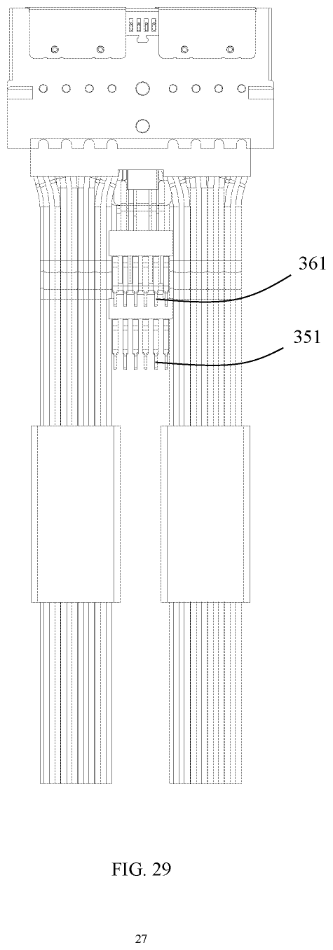

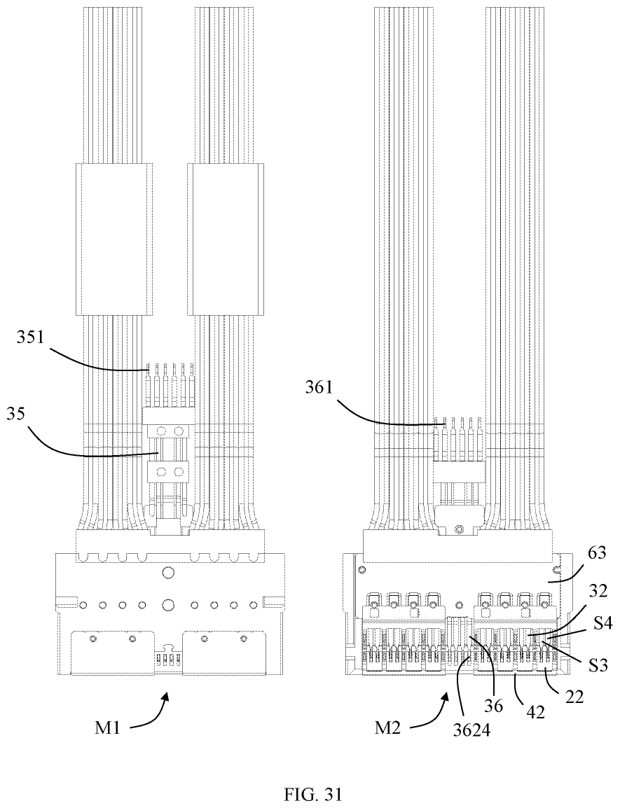

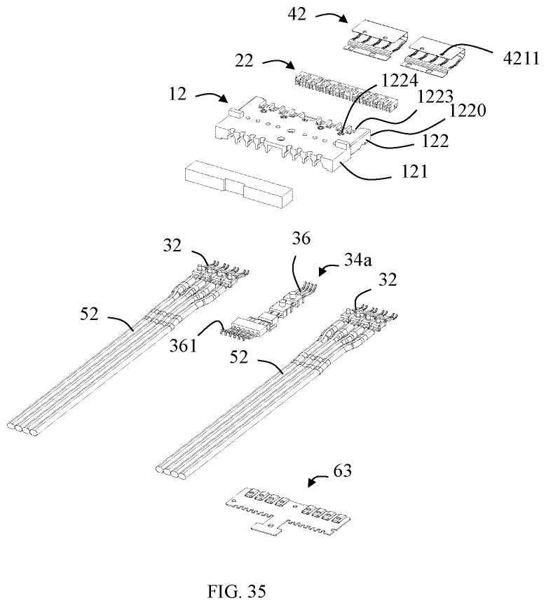

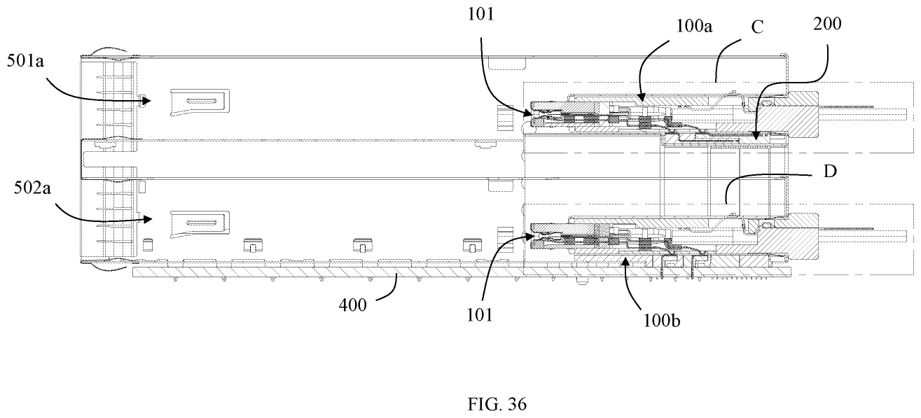

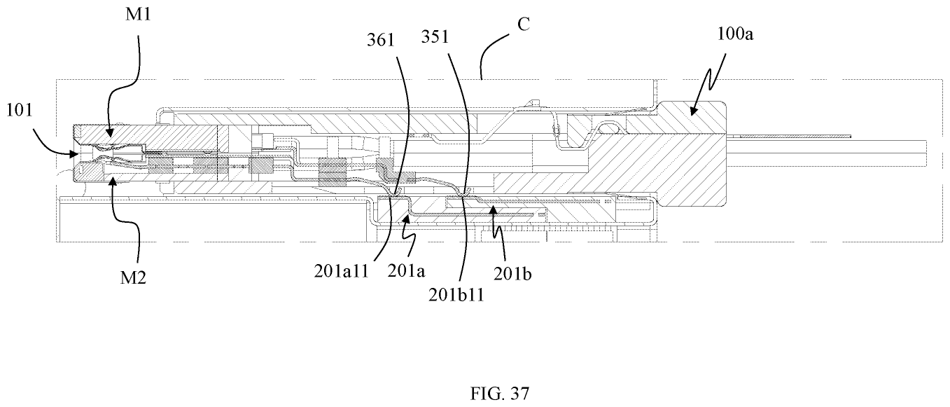

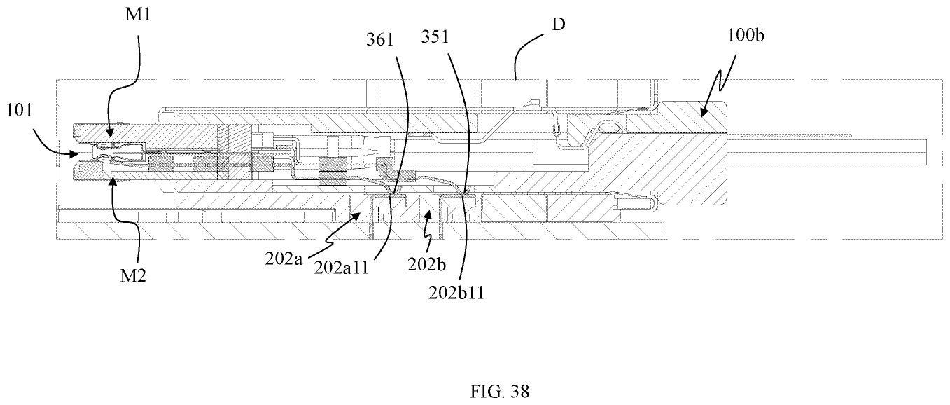

Referring to FIG. 1 to FIG. 38, a first embodiment of the present disclosure discloses a connector assembly including an electrical connector 100, an adapter module 200 cooperates with the electrical connector 100, a shielding cage 500 provided on a periphery of the adapter module 200, a circuit board 400, and a mating connector 300 configured to be at least partially inserted into the electrical connector 100. In the illustrated embodiment of the present disclosure, the shielding cage 500 is configured to be mounted to the circuit board 400. The adapter module 200 includes a first adapter block 201, a second adapter block 202, a support block 203 and a support shell 204. In the illustrated embodiment of the present disclosure, the electrical connector 100 is an OSFP (Octal Small Form-factor Pluggable) receptacle connector. More specifically, in the illustrated embodiment of the present disclosure, the electrical connector 100 is a receptacle connector. Correspondingly, the mating connector 300 is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating connector 300 is an SFP plug connector, a QSFP plug connector, a QSFP-DD plug connector, an SFP-DD plug connector or a DSFP plug connector, etc. It is understandable to those skilled in the art that the basic structure of the above types of the electrical connectors is regulated by corresponding association standards, and will not be described in detail here. Of course, it is understandable to those skilled in the art that the electrical connector 100 can also be other types of electrical connectors, including but not limited to USB connectors, HDMI connectors, DisplayPort connectors, RJ45 connectors, Thunderbolt connectors, etc. In the illustrated embodiment of the present disclosure, the electrical connector 100 is a semi-outlet receptacle connector. That is, part of the conductive terminals of the electrical connector 100 are connected to a cable, and another part of the conductive terminals are configured to be electrically connected to the circuit board 400, directly or indirectly.

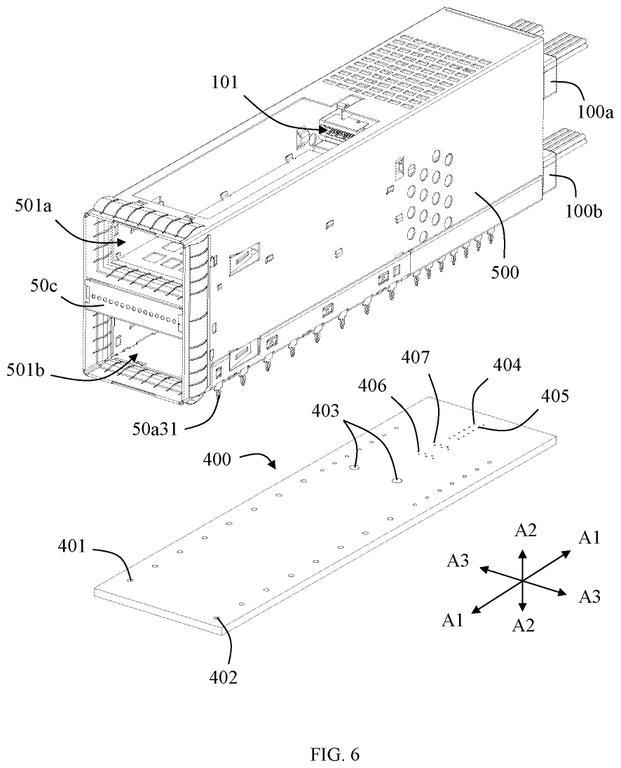

Referring to FIG. 6, in the illustrated embodiment of the present disclosure, the circuit board 400 includes a plurality of first mounting holes 401, a plurality of second mounting holes 402, a plurality of mounting positioning holes 403, a plurality of first conductive holes 404, a plurality of second conductive holes 405, a plurality of third conductive holes 406, and a plurality of fourth conductive holes 407. The first mounting holes 401 are arranged in a first row along the first direction A1-A1 (for example, a front-rear direction). The second mounting holes 402 are arranged in a second row in the first direction A1-A1 parallel to the first row. The mounting positioning holes 403 are arranged at intervals along a third direction A3-A3 (for example, a left-right direction). The mounting positioning holes 403 are located between the first row of first mounting holes 401 and the second row of second mounting holes 402 in the third direction A3-A3. The first conductive holes 404 are arranged in a third row in the first direction A1-A1 parallel to the first row. The second conductive holes 405 are arranged in a fourth row in the first direction A1-A1 parallel to the second row. The third conductive holes 406 are arranged in two rows which are interlaced along the first direction A1-A1, and each row is arranged in the third direction A3-A3. The fourth conductive holes 407 are arranged in two rows which are interlaced along the first direction A1-A1, and each row is arranged in the third direction A3-A3.

In the illustrated embodiment of the present disclosure, the mating connector 300 includes a first mating connector 300a and a second mating connector 300b. The first mating connector 300a is the same as the second mating connector 300b. The mating connector 300 includes a mating module, such as a tongue plate 301. The tongue plate 301 includes an upper surface, a lower surface, a plurality of first contact pads exposed on the upper surface and a plurality of second contact pads exposed to the lower surface. In the illustrated embodiment of the present disclosure, the electrical connector 100 defines a receiving slot 101 for at least partially receiving the mating connector 300. To simplify the description of the specific embodiments of the present disclosure, an insertion and extraction direction of the mating connector 300 and the electrical connector 100 is a first direction A1-A1 (for example, a front-rear direction); a thickness direction of the receiving slot 101 is a second direction A2-A2 (for example, a top-bottom direction); a width direction of the receiving slot 101 is a third direction A3-A3 (for example, a left-right direction). Each two of the first direction A1-A1, the second direction A2-A2 and the third direction A3-A3 are perpendicular to each other.

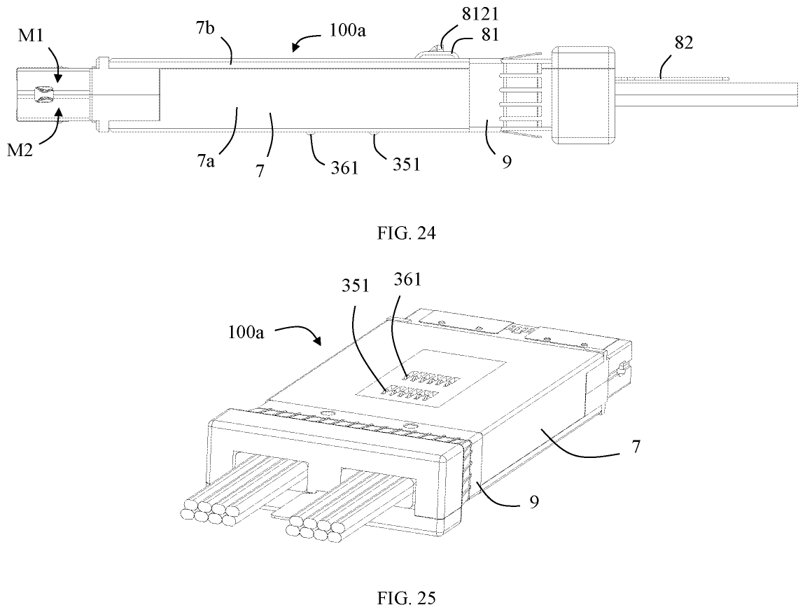

Referring to FIG. 24 to FIG. 36, in the illustrated embodiment of the present disclosure, the electrical connector 100 includes a first electrical connector 100a and a second electrical connector 100b. Each electrical connector 100 includes a first module M1, a second module M2, an outer insulating housing 7 fixed to the first module M1 and the second module M2, a locking device 8 provided on the outer insulating housing 7, and an elastic sleeve 9 sleeved on the outer insulating housing 7. The first module M1 and the second module M2 are provided separately and fixed together. In one embodiment of the present disclosure, the outer insulating housing 7 is made of an insulating material, and is fixed to the first module M1 and the second module M2. Specifically, in the illustrated embodiment of the present disclosure, the outer insulating housing 7 includes a first outer insulating housing 7a and a second outer insulating housing 7b.

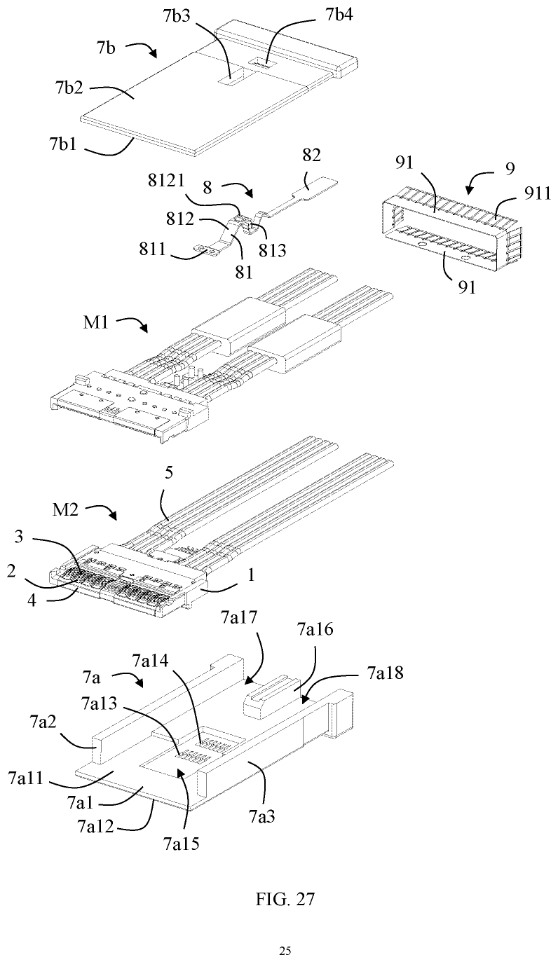

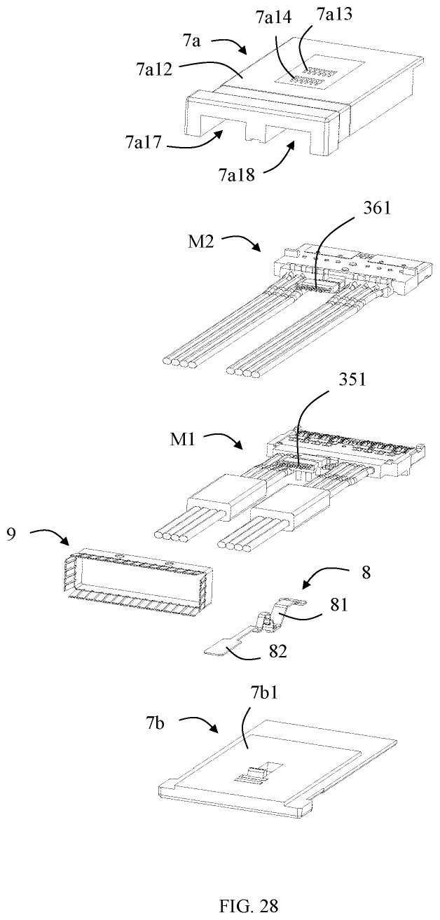

Referring to FIG. 27 and FIG. 28, the first outer insulating housing 7a includes a base plate 7a1, a first side wall portion 7a2 extending from one side of the base plate 7a1, and a second side wall portion 7a3 extending from another side of the base plate 7a1. The base plate 7a1 is provided with a first inner surface 7a11 (for example, an upper surface), a second outer surface 7a12 (for example, a lower surface) disposed opposite to the first inner surface 7a11, a plurality of first slots 7a13 extending through the first inner surface 7a11 and the first outer surface 7a12 along the second direction A2-A2, and a plurality of second slots 7a14 extending through the first inner surface 7a11 and the first outer surface 7a12 along the second direction A2-A2. In the illustrated embodiment of the present disclosure, the base plate 7a1 further defines a recessed portion 7a15 which is recessed downwardly from the first inner surface 7a11. The first slots 7a13 and the second slots 7a14 are located in the recessed portion 7a15, and are in communication with the recessed portion 7a15. The first slots 7a13 are arranged in the third direction A3-A3. The second slots 7a14 are arranged in the third direction A3-A3. The first slots 7a13 and the second slots 7a14 are arranged at intervals along the first direction A1-A1. Besides, the base plate 7a1 is further provided with a raised portion 7a16 located in the middle of a rear end. The base plate 7a1 includes a first accommodation space 7a17 located on one side of the raised portion 7a16, and a second accommodation space 7a18 located on another side of the raised portion 7a16.

The second outer insulating housing 7b is generally plate-shaped, and includes a second inner surface 7b1 (for example, a lower surface), a second outer surface 7b2 (for example, an upper surface) disposed opposite to the second inner surface 7b1, a first perforation 7b3 extending through the second inner surface 7b1 and the second outer surface 7b2 along the second direction A2-A2, and a second perforation 7b4 extending through the second inner surface 7b1 and the second outer surface 7b2 along the second direction A2-A2.

In the illustrated embodiment of the present disclosure, the first outer insulating housing 7a and the second outer insulating housing 7b are assembled and fixed to the first module M1 and the second module M2. The first module M1 and the second module M2 are sandwiched between the first outer insulating housing 7a and the second outer insulating housing 7b.

The locking device 8 includes a locking elastic arm 81 and a pull strap 82 buckled with the locking elastic arm 81. In the illustrated embodiment of the present disclosure, the locking elastic arm 81 is made of a metal material. The locking elastic arm 81 includes a holding portion 811, an elastic arm portion 812 extending from one end of the holding portion 811, and a fastening portion 813 extending from one end of the elastic arm portion 812. The holding portion 811 is fixed to the second outer insulating housing 7b. The elastic arm portion 812 extends upwardly with respect to the holding portion 811. The elastic arm portion 812 is provided with a raised locking protrusion 8121. The fastening portion 813 extends downwardly with respect to the elastic arm portion 812. The pull strap 82 extends backwardly beyond the outer insulating housing 7.

When the locking device 8 is installed in place, the locking protrusion 8121 protrudes upwardly beyond the second outer surface 7b2 from the first perforation 7b3. The pull strap 82 is at least partially located in the second perforation 7b4. The pull strap 82 extends backwardly beyond the second outer insulating housing 7b from the second inner surface 7b1 of the second outer insulating housing 7b to save space. It is understandable to those skilled in the art that by applying a certain tension to the pull strap 82 backwardly in the first direction A1-A1, the elastic arm portion 812 can be driven to elastically deform downwardly around the holding portion 811 at a base point, thereby causing the locking protrusion 8121 to be disconnected from a corresponding locking hole (to be described in detail afterwards).

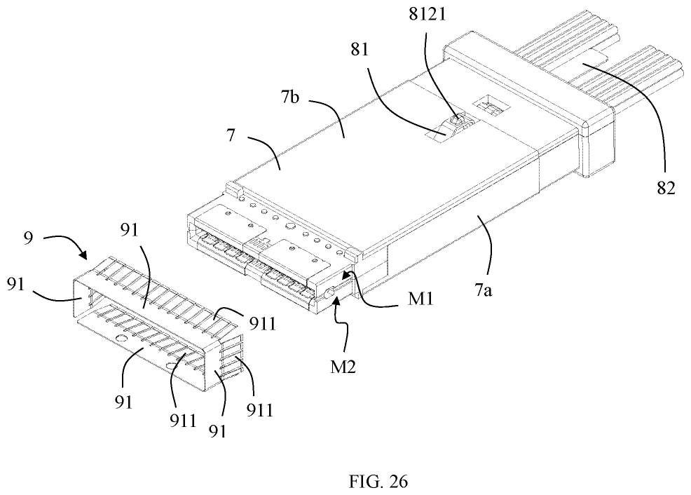

Referring to FIG. 26, in the illustrated embodiment of the present disclosure, the elastic sleeve 9 is made of a metal material. The elastic sleeve 9 is generally frame-shaped and includes four outer side walls 91. Each outer side wall 91 is provided with a plurality of cantilevered abutting arms 911 that are raised outward.

In the illustrated embodiment of the present disclosure, the first electrical connector 100a is the same as the second electrical connector 100b, and the following will be described only by taking the first electrical connector 100a as an example.

In one embodiment of the present disclosure, the first electrical connector 100a includes a housing, an insulating fixing block 2 fixed to the housing, a plurality of conductive terminals 3 installed to the housing and a plurality of cables 5 connected to the conductive terminals 3.

In an embodiment of the present disclosure, the housing is a conductive housing 1. The conductive housing 1 is a metal housing made of metal material so as to further improve the shielding effect and improve the quality of signal transmission. In another embodiment of the present disclosure, the conductive housing 1 may also be a composite housing formed by electroplating a metal material on an insulating material. The composite housing can also improve the shielding effect and improve the quality of signal transmission.

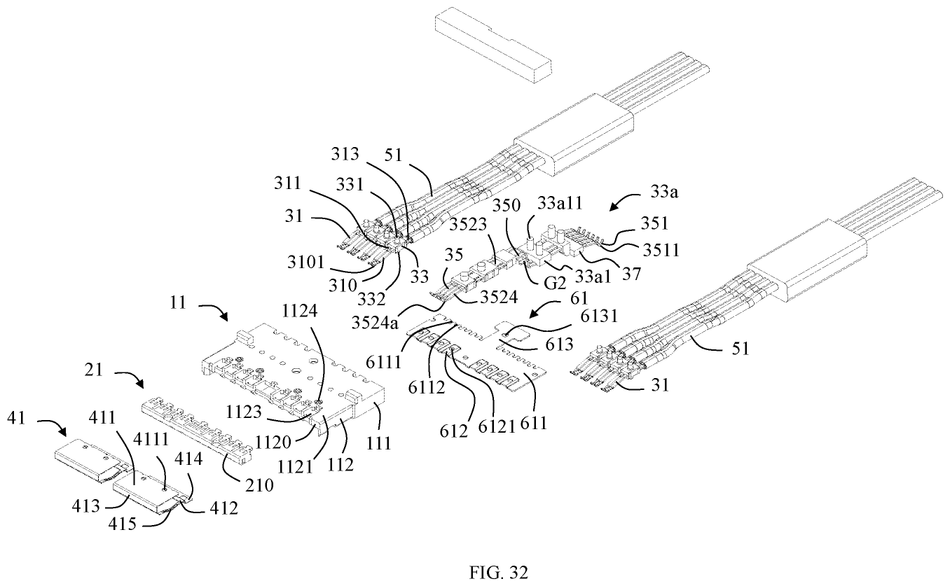

As shown in FIG. 32 to FIG. 35, in an embodiment of the present disclosure, the conductive housing 1 includes a first conductive housing 11 and a second conductive housing 12. The first conductive housing 11 and the second conductive housing 12 are fixed together. For example, after the first conductive housing 11 and the second conductive housing 12 are assembled, they are fixed together for example by welding or soldering or other methods. In the illustrated embodiment of the present disclosure, the first conductive housing 11 of the first module M1 and the second conductive housing 12 of the second module M2 are separately arranged and fixed together to jointly form the receiving slot 101.

In an embodiment of the present disclosure, the first conductive housing 11 includes a first base portion 111, a first protruding portion 112 extending forwardly from the first base portion 111 and a plurality of first terminal module installation slots 113 extending through the first base portion 111 and the first protruding portion 112 along the first direction A1-A1. The first protruding portion 112 includes a second upper surface 1121, a second lower surface 1122, and a plurality of first filling grooves 1123 extending upwardly through the second upper surface 1121 along the second direction A2-A2. The first filling grooves 1123 extend forwardly through a first front end surface 1120 of the first protruding portion 112 along the first direction A1-A1. The first protruding portion 112 further includes a plurality of first positioning posts 1124 protruding upwardly beyond the second upper surface 1121 along the second direction A2-A2.

The plurality of first terminal module installation slots 113 are spaced apart along the third direction A3-A3. The first conductive housing 11 includes a plurality of first partition walls 114 disposed at intervals along the third direction A3-A3. Two adjacent first terminal module installation slots 113 are separated by a corresponding first partition wall 114 along the third direction A3-A3. In other words, each first terminal module installation slot 113 is surrounded by four walls of the first conductive housing 11 on a length corresponding to the corresponding first partition wall 114, thereby improving the shielding effect. With this arrangement, each first terminal module installation slot 113 is relatively independent, thereby reducing signal crosstalk and improving the quality of data transmission. Each first partition wall 114 is provided with a first positioning block 1141 raised along the third direction A3-A3. The first positioning block 1141 is located at an end away from the first front end surface 1120.

In an embodiment of the present disclosure, the second conductive housing 12 includes a second base portion 121, a second protruding portion 122 extending forwardly from the second base portion 121 and a plurality of second terminal module installation slots 123 extending through the second base portion 121 and the second protruding portion 122 along the first direction A1-A1. The second protruding portion 122 includes a fourth upper surface 1221, a fourth lower surface 1222, and a plurality of second filling grooves 1223 extending downwardly through the fourth lower surface 1222. The second filling grooves 1223 extend forwardly through a second front end surface 1220 of the second protruding portion 122. The second protruding portion 122 further includes a plurality of second positioning posts 1224 protruding downwardly beyond the second lower surface 1122.

In an embodiment of the present disclosure, the plurality of second terminal module installation slots 123 are arranged at intervals along the third direction A3-A3. The second conductive housing 12 includes a plurality of second partition walls 124 disposed at intervals along the third direction A3-A3. Two adjacent second terminal module installation slots 123 are separated by corresponding second partition walls 124 along the third direction A3-A3. In other words, each second terminal module installation slot 123 is surrounded by four walls of the second conductive housing 12 on a length corresponding to the second partition wall 124, thereby improving the shielding effect. With this arrangement, each second terminal module installation slot 123 is relatively independent, thereby reducing signal crosstalk and improving the quality of data transmission. Each second partition wall 124 is provided with a second positioning block 1241 raised along the third direction A3-A3. The second positioning block 1241 is located at an end away from the second front end surface 1220.

Referring to FIG. 32 to FIG. 35, in the illustrated embodiment of the present disclosure, the insulating fixing block 2 includes a first insulating fixing block 21 and a second insulating fixing block 22. The first insulating fixing block 21 is fixed in the first filling grooves 1123. The second insulating fixing block 22 is fixed in the second filling grooves 1223. Preferably, in order to increase the bonding force between the first insulating fixing block 21 and the first conductive housing 11, the first insulating fixing block 21 is molded in the first filling grooves 1123. Similarly, in order to increase the bonding force between the second insulating fixing block 22 and the second conductive housing 12, the second insulating fixing block 22 is molded in the second filling grooves 1223.

The first insulating fixing block 21 defines a plurality of first slits 211 and a plurality of second slits 212, in which adjacent first slit 211 and second slit 212 form a group and communicate with a corresponding first terminal module installation slot 113. The first insulating fixing block 21 further includes a first front surface 210 which is coplanar with the first front end surface 1120 of the first protruding portion 112.

Similarly, the second insulating fixing block 22 defines a plurality of third slits 221 and a plurality of fourth slits 222. Adjacent third slit 221 and fourth slit 222 form a group and communicate with a corresponding second terminal module installation slot 123. The second insulating fixing block 22 includes a second front surface 220 which is coplanar with the second front end surface 1220 of the second protruding portion 122.

As shown in FIG. 32 to FIG. 35, the plurality of conductive terminals 3 include a plurality of first conductive terminals 31, a plurality of second conductive terminals 32, a plurality of first board-end terminals 35 and a plurality of second board-end terminals 36. Each first conductive terminal 31 includes a first fixing portion 311 extending along the first direction A1-A1, a first contact arm 310 extending forwardly from a front end of the first fixing portion 311, and a first tail portion 313 extending backwardly from a rear end of the first fixing portion 311. The first contact arm 310 includes a first contact portion 3101 that extends into the receiving slot 101. The first contact portions 3101 are configured to be in contact with first signal contact pads of the tongue plate 301. In the illustrated embodiment of the present disclosure, the first tail portions 313 extend backwardly and horizontally to be electrically connected to first cables 51.

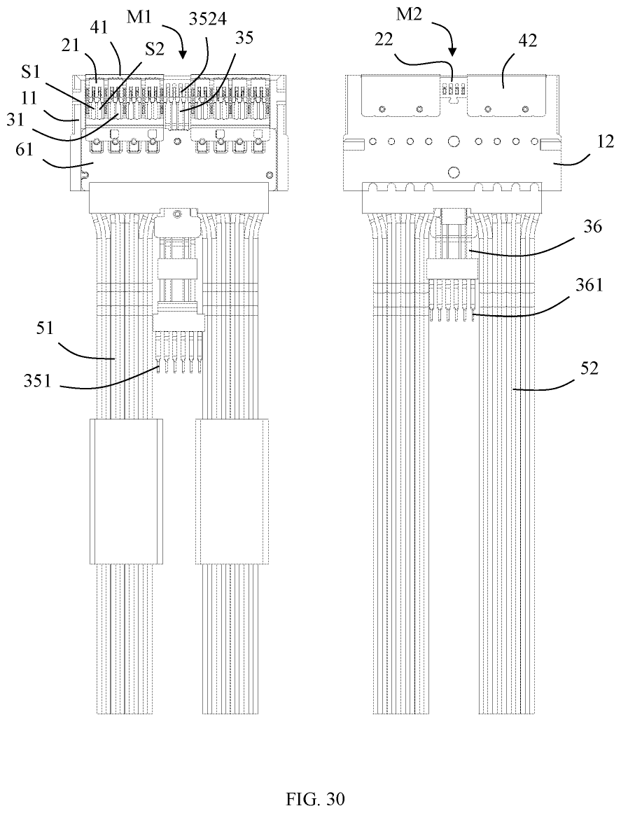

Referring to FIG. 30 to FIG. 35, in the illustrated embodiment of the present disclosure, the plurality of first conductive terminals 31 are divided into a plurality of groups. Each group of first conductive terminals 31 includes a first signal terminal S1 and a second signal terminal S2 located adjacent to the first signal terminal S1. Preferably, the first signal terminal S1 and the second signal terminal S2 in each group of first conductive terminals 31 form a differential pair to improve signal transmission speed, thereby being suitable for high-speed signal transmission.

In the illustrated embodiment of the present disclosure, the first electrical connector 100a further includes a first holding block 33 fixed on the first signal terminal S1 and the second signal terminal S2 of each group of first conductive terminals 31. In an embodiment of the present disclosure, the first signal terminal S1 and the second signal terminal S2 are insert-molded with the first holding block 33, so as to form an integrated first terminal module 31a. The first contact portions 3101 of the first signal terminal S1 and the second signal terminal S2 in each first terminal module 31a are configured to be in contact with the first signal contact pads of the mating connector 300, respectively.

In the illustrated embodiment of the present disclosure, the first holding block 33 is fixed to the middle portions of the first fixing portions 311 of the first signal terminal S1 and the second signal terminal S2. The first holding block 33 is installed and fixed in the first terminal module installation slot 113 so that the first conductive terminal 31 does not come into contact with the first conductive housing 11 and cause a short circuit. In the illustrated embodiment of the present disclosure, the first holding block 33 includes a first protruding post 331 protruding along the third direction A3-A3 and a first positioning protruding post 332 protruding along the third direction A3-A3. The first protruding post 331 and the first positioning protruding post 332 protrude in opposite directions. The first protruding post 331 is used for positioning with a corresponding through hole of the first conductive housing 11 and the first protruding post 331 extends through the first conductive housing 11.

Similarly, each second conductive terminal 32 includes a second fixing portion 321 extending along the first direction A1-A1, a second contact arm 320 extending forwardly from a front end of the second fixing portion 321, and a second tail portion 323 extending backwardly from a rear end of the second fixing portion 321. The second contact arm 320 includes a second contact portion 3201 that extends into the receiving slot 101. The second contact portions 3201 are configured to be in contact with the second signal contact pads of the tongue plate 301. In the illustrated embodiment of the present disclosure, the second tail portions 323 extend backwardly and horizontally from the second fixing portions 321 to be electrically connected to second cables 52.

Referring to FIG. 30 to FIG. 35, in the illustrated embodiment of the present disclosure, the plurality of second conductive terminals 32 are divided into a plurality of groups, and each group of second conductive terminals 32 includes a third signal terminal S3 and a fourth signal terminal S4 located adjacent to the third signal terminal S3. Preferably, the third signal terminal S3 and the fourth signal terminal S4 in each group of second conductive terminals 32 form a differential pair to improve signal transmission speed, thereby being suitable for high-speed signal transmission.

In the illustrated embodiment of the present disclosure, the first electrical connector 100a further includes a second holding block 34 fixed on the third signal terminal S3 and the fourth signal terminal S4 of each group of second conductive terminals 32. In one embodiment of the present disclosure, the third signal terminal S3 and the fourth signal terminal S4 are insert-molded with the second holding block 34 to form an integrated second terminal module 32a. The second contact portions 3201 of the third signal terminal S3 and the fourth signal terminal S4 in each second terminal module 32a are configured to be in contact with the second signal contact pads of the mating connector 300.

In the illustrated embodiment of the present disclosure, the second holding block 34 is fixed to the middle portions of the second fixing portions 321 of the third signal terminal S3 and the fourth signal terminal S4. The second holding block 34 is installed and fixed in the second terminal module installation slot 123 so that the second conductive terminal 32 does not come into contact with the second conductive housing 12 to cause a short circuit. In the illustrated embodiment of the present disclosure, the second holding block 34 includes a second protruding post 341 protruding along the third direction A3-A3 and a second positioning protruding post 342 protruding along the third direction A3-A3. The second protruding post 341 and the second positioning protruding post 342 protrude in opposite directions. The second protruding post 341 is used for positioning with a corresponding through hole of the second conductive housing 12, and the second protruding post 341 extends through the second conductive housing 12.

In the illustrated embodiment of the present disclosure, the first electrical connector 100a further includes a first non-high-speed terminal module 33a and a second non-high-speed terminal module 34a. The first non-high-speed terminal module 33a includes at least one first insulating block 33a1, and the first board-end terminals 35 fixed to the first insulating block 33a1. It is understandable to those skilled in the art that the first board-end terminals 35 include but are not limited to non-high-speed signal terminals, power terminals, and the like.

In the illustrated embodiment of the present disclosure, the first board-end terminals 35 include a first ground terminal G1, a second ground terminal G2 and at least one first board-end additional terminal 350 located between the first ground terminal G1 and the second ground terminal G2. Each first board-end terminal 35 includes a first elastic tail portion 351. In the illustrated embodiment of the present disclosure, each first elastic tail portion 351 includes a first arc-shaped abutting surface 3511.

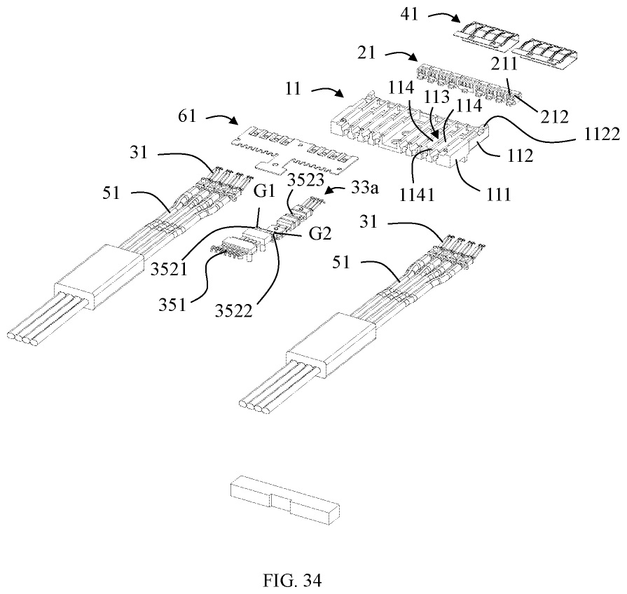

Besides, the first ground terminal G1 further includes a first abutting portion 3521 (as shown in FIG. 34). The first abutting portion 3521 extends along the first direction A1-A1.

Similarly, the second ground terminal G2 further includes a second abutting portion 3522 (as shown in FIG. 34). The second abutting portion 3522 extends along the first direction A1-A1.

Referring to FIG. 32, each first board-end additional terminal 350 includes a first extension portion 3523 and a first additional contact arm 3524 connected to the first extension portion 3523. The first additional contact arm 3524 includes a first additional abutting portion 3524a protruding into the receiving slot 101. The first extension portion 3523 extends along the first direction A1-A1. The first elastic tail portion 351 of the first board-end additional terminal 350 is connected to the first extension portion 3523, and extends in the first direction A1-A1.

In the illustrated embodiment of the present disclosure, the first abutting portion 3521, the second abutting portion 3522, and the first extension portion 3523 are parallel to one another. A length of the first extension portion 3523 along the first direction A1-A1 is greater than a length of the first abutting portion 3521 along the first direction A1-A1, and the length of the first extension portion 3523 along the first direction A1-A1 is greater than a length of the second abutting portion 3522 along the first direction A1-A1. Neither the first ground terminal G1 nor the second ground terminal G2 is provided with any elastic contact arm protruding into the receiving slot 101 and configured to be electrically connected to the mating connector 300. In other words, neither the first ground terminal G1 nor the second ground terminal G2 is provided with the first additional contact arm 3524 similar to the first board-end additional terminal 350.

In the illustrated embodiment of the present disclosure, the first abutting portion 3521 and the second abutting portion 3522 are located at a first height along the second direction A2-A2. The first extension portion 3523 is located at a second height along the second direction A2-A2. The first height is different from the second height.

In the illustrated embodiment of the present disclosure, the first extension portion 3523 of the first board-end additional terminal 350 is partially insert-molded with the first insulating block 33a1. The first additional contact arm 3524 extends out of the first insulating block 33a1. The first insulating block 33a1 is provided with at least one first positioning protruding post 33a11.

The first ground terminal G1, the second ground terminal G2 and the first board-end additional terminal 350 are all insert-molded with the first mounting block 37 to be integrated into a whole. The first mounting tail portions 351 of the first ground terminal G1, the second ground terminal G2 and the first board-end additional terminal 350 all extend beyond the first mounting block 37.

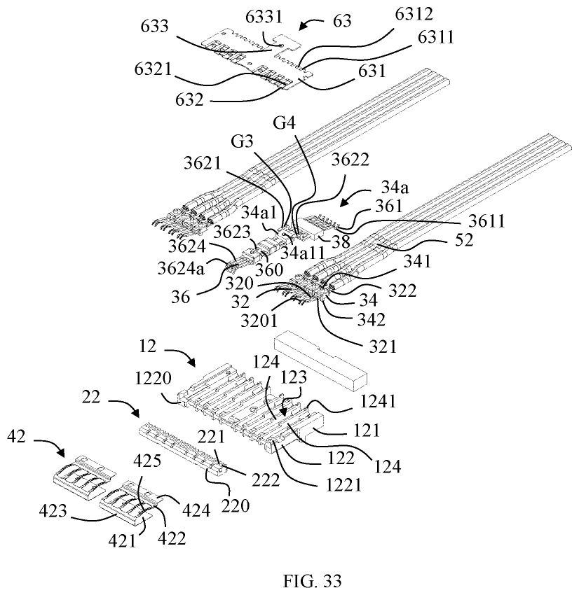

Similarly, as shown in FIG. 33, the second non-high-speed terminal module 34a includes at least one second insulating block 34a1, a plurality of second board-end terminals 36 fixed to the second insulating block 34a1, and a second mounting block 38 fixed to the second board-end terminals 36. It is understandable to those skilled in the art that the second board-end terminals 36 include, but are not limited to, non-high-speed signal terminals, power terminals, and the like.

In the illustrated embodiment of the present disclosure, the second board-end terminal 36 includes a third ground terminal G3, a fourth ground terminal G4, and at least one second board-end additional terminal 360 located between the third ground terminal G3 and the fourth ground terminal G4. Each second board-end terminal 36 includes a second elastic tail portion 361. In the illustrated embodiment of the present disclosure, each second elastic tail portion 361 includes a second arc-shaped abutting surface 3611.

Besides, the third ground terminal G3 further includes a third abutting portion 3621. The third abutting portion 3621 extends along the first direction A1-A1. The second elastic tail portion 361 of the third ground terminal G3 extends along the first direction A1-A1.

Similarly, the fourth ground terminal G4 further includes a fourth abutting portion 3622. The fourth abutting portion 3622 extends along the first direction A1-A1. The second elastic tail portion 361 of the fourth ground terminal G4 extends along the first direction A1-A1.

The second board-end additional terminal 360 includes a second extension portion 3623 and a second additional contact arm 3624 connected to the second extension portion 3623. The second additional contact arm 3624 includes a second additional abutting portion 3624a protruding into the receiving slot 101. The second extension portion 3623 extends along the first direction A1-A1.

In the illustrated embodiment of the present disclosure, the third abutting portion 3621, the fourth abutting portion 3622 and the second extension portion 3623 are parallel to one another. A length of the second extension portion 3623 along the first direction A1-A1 is greater than a length of the third abutting portion 3621 along the first direction A1-A1, and the length of the second extension portion 3623 along the first direction A1-A1 is greater than a length of the fourth abutting portion 3622 along the first direction A1-A1. Neither the third ground terminal G3 nor the fourth ground terminal G4 is provided with any elastic contact arm protruding into the receiving slot 101 and configured to be electrically connected to the mating connector 300. In other words, neither the third ground terminal G3 nor the fourth ground terminal G4 is provided with the second additional contact arm 3624 similar to the second board-end additional terminal 360.

In the illustrated embodiment of the present disclosure, the third abutting portion 3621 and the fourth abutting portion 3622 are located at a third height along the second direction A2-A2. The second extension portion 3623 is located at a fourth height along the second direction A2-A2. The third height is different from the fourth height.

In the illustrated embodiment of the present disclosure, the second extension portion 3623 of the second board-end additional terminal 360 is partially insert-molded with the second insulating block 34a1. The second additional contact arm 3624 extends out of the second insulating block 34a1. The second insulating block 34a1 is provided with at least one second positioning protruding post 34a11.

As shown in FIG. 32 and FIG. 33, in an embodiment of the present disclosure, a plurality of first insulating blocks 33a1 and a plurality of second insulating blocks 34a1 are provided, respectively.

The third ground terminal G3, the fourth ground terminal G4 and the second board-end additional terminals 360 are all insert-molded with the second mounting block 38 to be integrated into a whole. The second mounting tail portions 361 of the third ground terminal G3, the fourth ground terminal G4 and the second board-end additional terminals 360 all extend beyond the second mounting block 38.

Referring to FIG. 32 to FIG. 35, in one embodiment of the present disclosure, the first electrical connector 100a further includes at least one ground sheet 4 mounted to the conductive housing 1. The ground sheet 4 includes a first ground sheet 41 and a second ground sheet 42. In the illustrated embodiment of the present disclosure, two first ground sheets 41 are provided and they are made of metal material. Two second ground sheets 42 are provided and they are made of metal material.

Each first ground sheet 41 is generally U-shaped and includes a first mounting plate 411, a second mounting plate 412 opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124.

The first connecting plate 413 abuts against and at least partially covers the first front surface 210 of the first insulating fixing block 21. The first connecting plate 413 is located at a front end of the receiving slot 101 along the first direction A1-A1. When the mating connector 300 is inserted, the tongue plate 301 may be in contact with the first connecting plate 413 first, thereby facilitating the discharge of static electricity. The second mounting plate 412 is provided with a plurality of first grounding elastic arms 415 which are disposed at intervals along the third direction A3-A3. The first grounding elastic arms 415 are disposed on two sides of the first contact arms 310 of each group of first conductive terminals 31 so as to improve the shielding effect and improve the quality of signal transmission.

Each second ground sheet 42 is generally U-shaped and includes a third mounting plate 421, a fourth mounting plate 422 opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224.

The second connecting plate 423 abuts against and at least partially covers the second front surface 220 of the second insulating fixing block 22. The second connecting plate 423 is located at the front end of the receiving slot 101 along the first direction A1-A1. When the mating connector 300 is inserted, the tongue plate 301 may be in contact with the second connecting plate 423 first, thereby facilitating the discharge of static electricity. The fourth mounting plate 422 is provided with a plurality of second grounding elastic arms 425 which are disposed at intervals along the third direction A3-A3. The second grounding elastic arms 425 are disposed on two sides of the second contact arms 320 of each group of second conductive terminals 32, respectively, so as to improve the shielding effect and improve the quality of signal transmission.

Referring to FIG. 32, in the illustrated embodiment of the present disclosure, the first module M1 further includes a first shielding plate 61 installed on the first conductive housing 11. In an embodiment of the present disclosure, the first shielding plate 61 is a metal shielding plate. The first shielding plate 61 includes a first main body portion 611 and a first plate-shaped extension portion 613 extending from the first main body portion 611. The first main body portion 611 includes a plurality of first stamped portions 612 that are integrally stamped from the first main body portion 611. Each first stamped portion 612 defines a first positioning through hole 6121 extending through the first stamped portion 612 along the second direction A2-A2. The first main body portion 611 further includes a plurality of first notches 6111 extending through a side edge of the first main body portion 611 and a plurality of first positioning grooves 6112 extending through the side edge. The plurality of first notches 6111 and the plurality of first positioning grooves 6112 are spaced apart along the third direction A3-A3. The first notches 6111 and the first positioning grooves 6112 are alternately arranged along the third direction A3-A3. The first shielding plate 61 is able to form a surrounding shielding structure together with the first conductive housing 11, thereby improving the shielding effect. The first positioning groove 6112 cooperates with the first positioning block 1141 to achieve positioning. The first notch 6111 corresponds to the first shielding layer 513 of the first cable 51. The first notch 6111 is configured to be filled with solder so that the first main body portion 611 and the first shielding layer 513 can be fixed by soldering or welding, thereby helping to further improve the ground shielding effect. The first positioning through hole 6121 matches the first positioning protruding post 332.

In the illustrated embodiment of the present disclosure, the first plate-shaped extension portion 613 is generally T-shaped and defines at least one first positioning through hole 6131. The first positioning protruding post 33a11 passes through the first positioning through hole 6131 to achieve assembly positioning. The first shielding plate 61 is at least partially supported on the first insulating block 33a1.

The first plate-shaped extension portion 613 of the first shielding plate 61 is in contact with the first abutting portion 3521 of the first ground terminal G1 and the second abutting portion 3522 of the second ground terminal G2, so that the first shielding plate 61 can be grounded with the circuit board 400, indirectly, through the first elastic tail portion 351 of the first ground terminal G1 and the first elastic tail portion 351 of the second ground terminal G2. In an embodiment of the present disclosure, the first plate-shaped extension portion 613 of the first shielding plate 61 is fixed to the first abutting portion 3521 of the first ground terminal G1 and the second abutting portion 3522 of the second ground terminal G2 by soldering or welding. The first shielding plate 61 is not in contact with the first extension portion 3523 of the first board-end additional terminal 350 to prevent short circuit.

In the illustrated embodiment of the present disclosure, the second module M2 further includes a second shielding plate 63 installed on the second conductive housing 12. In an embodiment of the present disclosure, the second shielding plate 63 is a metal shielding plate. The second shielding plate 63 includes a second main body portion 631 and a second plate-shaped extension portion 633 extending from the second main body portion 631. The second main body portion 631 includes a plurality of second stamped portions 632 that are integrally stamped from the second main body portion 631. Each second stamped portion 632 defines a second positioning through hole 6321 extending through the second stamped portion 632 along the second direction A2-A2. The second main body portion 631 further defines a plurality of second notches 6311 extending through a side edge of the second main body portion 631 and a plurality of second positioning grooves 6312 extending through the side edge. The plurality of second notches 6311 and the plurality of second positioning grooves 6312 are spaced apart along the third direction A3-A3. The second notches 6311 and the second positioning grooves 6312 are alternately arranged along the third direction A3-A3. The second shielding plate 63 is able to form a surrounding shielding structure together with the second conductive housing 12, thereby improving the shielding effect. The second positioning groove 6312 cooperates with the second positioning block 1241 to achieve positioning. The second notch 6311 corresponds to the second shielding layer 523 of the second cable 52. The second notch 6311 is configured to be filled with solder so that the second main body portion 631 and the second shielding layer 523 can be fixed by soldering or welding, thereby helping to further improve the ground shielding effect. The second positioning through hole 6321 matches the second positioning protruding post 342.

In the illustrated embodiment of the present disclosure, the second plate-shaped extension portion 633 is generally T-shaped and defines at least one second positioning through hole 6331. The second positioning protruding post 34a11 passes through the second positioning through hole 6331 to achieve assembly positioning. The second shielding plate 63 is at least partially supported on the second insulating block 34a1.

The second plate-shaped extension portion 633 of the second shielding plate 63 is in contact with the third abutting portion 3621 of the third ground terminal G3 and the fourth abutting portion 3622 of the fourth ground terminal G4, so that the second shielding plate 63 can be grounded with the circuit board 400, indirectly, through the second elastic tail portion 361 of the third ground terminal G3 and the second elastic tail portion 361 of the fourth ground terminal G4. In an embodiment of the present disclosure, the second plate-shaped extension portion 633 of the second shielding plate 63 is fixed to the third abutting portion 3621 of the third ground terminal G3 and the fourth abutting portion 3622 of the fourth ground terminal G4 by soldering or welding. The second shielding plate 63 is not in contact with the second extension portion 3623 of the second board-end additional terminal 360 to prevent short circuit.

When assembling the first electrical connector 100a, firstly, the first insulating fixing block 21 is fixed in the first filling grooves 1123, and the second insulating fixing block 22 is fixed in the second filling grooves 1223.

Then, the first terminal modules 31a and the second terminal modules 32a are installed in the corresponding first terminal module installation slots 113 and the second terminal installation slots 123 along the second direction A2-A2. At this time, the first holding block 33 is fixed in the corresponding first terminal module installation slot 113, the first fixing portions 311 of the first conductive terminals 31 are disposed overhead in the corresponding first terminal module installation slot 113, in order to avoid short circuit due to contact with the first conductive housing 11. The first contact arm 310 of the first signal terminal S1 at least partially extends into the first slit 211 of the first insulating fixing block 21. The first contact arm 310 of the second signal terminal S2 at least partially extends into the second slit 212 of the first insulating fixing block 21. Similarly, the second holding block 341 is fixed in the corresponding second terminal module installation slot 123, the second fixing portions 321 of the second conductive terminal 32 are disposed overhead in the second terminal module installation slot 123, in order to avoid short circuit due to contact with the second conductive housing 12. The second contact arm 320 of the third signal terminal S3 at least partially extends into the third slit 221 of the second insulating fixing block 22. The second contact arm 320 of the fourth signal terminal S4 at least partially extends into the fourth slit 222 of the second insulating fixing block 22.

Then, the first cables 51 and the second cables 52 are installed into the corresponding first terminal module installation slots 113 and the second terminal module installation slots 123, respectively. The first cable 51 is in contact with the first tail portion 313 of the first conductive terminal 31. The second cable 52 is in contact with the second tail portion 323 of the second conductive terminal 32.

In the illustrated embodiment of the present disclosure, the first cables 51 and the second cables 52 are inserted into the corresponding first terminal module installation slots 113 and the second terminal module installation slots 123, respectively. The first cable 51 is located at a bottom of the first tail portion 313 of the first conductive terminal 31. The second cable 52 is located on a top of the second tail portion 323 of the second conductive terminal 32. Preferably, in an embodiment of the present disclosure, the first cable 51 and the first tail 313 of the first conductive terminal 31 are fixed by soldering or welding. The second cable 52 and the second tail 323 of the second conductive terminal 32 are fixed by soldering or welding.

Then, the first shielding plate 61 and the second shielding plate 63 are installed on the first conductive housing 11 and the second conductive housing 12, respectively.

Then, the first ground sheet 41 and the second ground sheet 42 are installed on the first conductive housing 11 and the second conductive housing 12, respectively.

Then, the first conductive housing 11 and the second conductive housing 12 are attached to each other. The first base portion 111 and the second base portion 121 correspond along the top-bottom direction. The first protruding portion 112 and the second protruding portion 122 correspond along the top-bottom direction. In the second direction A2-A2, the first shielding plate 61 and the second shielding plate 63 are located between the plurality of first conductive terminals 31 and the plurality of second conductive terminals 32 to reduce crosstalk between the first conductive terminals 31 and the second conductive terminals 32. Besides, in order to further increase the bonding force of the first conductive housing 11 and the second conductive housing 12, the first conductive housing 11 and the second conductive housing 12 are soldered or welded at the joint position. When the first conductive housing 11 and the second conductive housing 12 are fixed, the receiving slot 101 for receiving the mating connector 300 is formed between the first protruding portion 112 and the second protruding portion 122.

Then, the locking device 8 is installed on the second outer insulating housing 7b. The first outer insulating housing 7a and the second outer insulating housing 7b are assembled and fixed to the first module M1 and the second module M2. The first module M1 and the second module M2 are sandwiched between the first outer insulating housing 7a and the second outer insulating housing 7b. At this time, the first elastic tail portions 351 of cantilever-shaped configurations and the second elastic tail portions 361 of cantilever-shaped configurations extend downwardly beyond the second outer insulating housing 7b from the first slots 7a13 and the second slots 7a14, respectively. The first elastic tail portions 351 and the second elastic tail portions 361 are arranged in two rows parallel to each other.

Finally, the elastic sleeve 9 is sleeved on the first outer insulating housing 7a and the second outer insulating housing 7b.

It is understandable to those skilled in the art that the order of the steps in the above assembly method can be flexibly adjusted as needed, and will not be described again in the present disclosure.

Referring to FIG. 1 to FIG. 16, the shielding cage 500 is assembled and fixed to the circuit board 400. In the illustrated embodiment of the present disclosure, the shielding cage 500 is made of a metal material to provide a relatively good shielding effect. In the illustrated embodiment of the present disclosure, the shielding cage 500 defines a plurality of accommodating cavities 501 which are stacked along the second direction A2-A2. In the illustrated embodiment of the present disclosure, the shielding cage 500 includes a first shielding cage 50a, a second shielding cage 50b cooperating with the first shielding cage 50a, an intermediate shielding cage 50c, a front-end shielding cage 50d, and an additional shielding cage 50e.

The first shielding cage 50a includes a first wall portion 50a1 (for example, a top wall), a second wall portion 50a2 (for example, a left side wall) bent downwardly from one side of the first wall portion 50a1, and a third wall portion 50a3 (for example, a right side wall) bent downwardly from another side of the first wall portion 50a1. The first wall portion 50a1 defines a first opening portion 50a11 extending upwardly through the first wall portion 50a1 along the second direction A2-A2. The second wall portion 50a2 is provided with a plurality of first press-fit pins 50a21 extending in the second direction A2-A2. Each first press-fit pin 50a21 defines a first through hole so that the first press-fit pin 50a21 has a certain elastic deformation capability to facilitate being pressed into the first mounting hole 401 of the circuit board 400. The third wall portion 50a3 is provided with a plurality of second press-fit pins 50a31 extending in the second direction A2-A2. Each second press-fit pin 50a31 defines a second through hole so that the second press-fit pin 50a31 has a certain elastic deformation capability to facilitate being pressed into the second mounting hole 402 of the circuit board 400.

The first shielding cage 50a and the second shielding cage 50b are hooked together to form a rectangular first space. The second shielding cage 50b defines a plurality of first slits 50b1 and a plurality of second slits 50b2. The first press-fit pins 50a21 extend downwardly through the first slits 50b1, and the second press-fit pins 50a31 extend downwardly through the second slits 50b2 for being easily mounted to the circuit board 400.

The intermediate shielding cage 50c includes a first plate 50c1, a second plate 50c2 disposed opposite to the first plate 50c1, and a connecting plate 50c3 fixed to front ends of the first plate 50c1 and the second plate 50c2. The intermediate shielding cage 50c is fixed in the first shielding cage 50a to separate the first space into a first accommodating cavity 501a above the intermediate shielding cage 50c, and a second accommodating cavity 501b below the intermediate shielding cage 50c.

The front-end shielding cage 50d is generally of a frame-shaped configuration, and is fixed to front ends of the first shielding cage 50a and the second shielding cage 50b.

The additional shielding cage 50e is fixed to the first shielding cage 50a. The additional shielding cage 50e defines a first locking hole 50e1 which is exposed to the first accommodating cavity 501a. The first accommodating cavity 501a is configured to accommodate the first electrical connector 100 a. The locking protrusion 8121 of the first electrical connector 100a is locked in the first locking hole 50e1 to install and fix the first electrical connector 100a in the shielding cage 500.

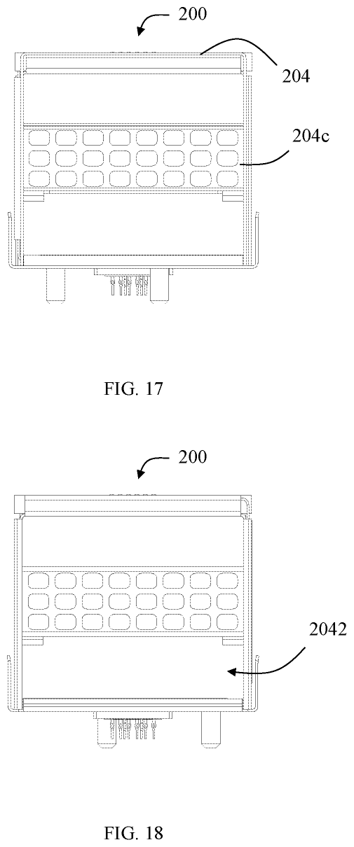

Referring to FIG. 17 to FIG. 23, in the illustrated embodiment of the present disclosure, the first adapter block 201 includes a first adapter terminal module 201a and a second adapter terminal module 201b. The first adapter terminal module 201a includes a plurality of first adapter terminals 201a1 and a plurality of first insulating retention blocks 201a2 fixed to the first adapter terminals 201a1. Each first adapter terminal 201a1 includes a first extension arm portion 201a11 extending in the first direction A1-A1, a first outer bent arm portion 201a12 connected to the first extending arm portion 201a11 and extending outwardly in the third direction A3-A3, a first outer arm portion 201a13 connected to the first outer bent arm portion 201a12 and extending in the second direction A2-A2, a first inner bent arm portion 201a14 connected to the first outer arm portion 201a13 and extending inwardly in the third direction A3-A3, and a first mounting tail portion 201a15 connected to the first inner bent arm portion 201a14 and extending in the second direction A2-A2. The first extension arm portion 201a11 is provided with a first contact surface 201a111 in a flat shape. The first contact surface 201a111 is exposed to the first insulating retention block 201a2. The first mounting tail portions 201a15 are arranged in two rows along the third direction A3-A3. Each first mounting tail portion 201a15 defines a first fish-eye hole 201a151, so that the first mounting tail portions 201a15 have a certain elastic deformation capability to facilitate being pressed into the corresponding first conductive holes 404 and the corresponding second conductive holes 405 of the circuit board 400.

Similarly, the second adapter terminal module 201b includes a plurality of second adapter terminals 201b1, and a plurality of second insulating retention blocks 201b2 fixed to the second adapter terminals 201b1. Each second adapter terminal 201b1 includes a second extension arm portion 201b11 extending in the first direction A1-A1, a second outer bent arm portion 201b12 connected to the second extension arm portion 201b11 and extending outwardly in the third direction A3-A3, a second outer arm portion 201b13 connected to the second outer bent arm portion 201b12 and extending in the second direction A2-A2, a second inner bent arm portion 201b14 connected to the second outer arm portion 201b13 and extending inwardly in the third direction A3-A3, and a second mounting tail portion 201b15 connected to the second inner bent arm portion 201b14 and extending in the second direction A2-A2. The second extension arm portion 201b11 is provided with a second contact surface 201b111 in a flat shape. The second contact surface 201b111 is exposed to the second insulating retention block 201b2. The second mounting tail portions 201b15 are arranged in two rows along the third direction A3-A3. Each second mounting tail portion 201b15 defines a second fish-eye hole 201b15, so that the second mounting tail portions 201b15 have a certain elastic deformation capability to facilitate being pressed into the corresponding first conductive holes 404 and the corresponding second conductive holes 405 of the circuit board 400.

In one embodiment of the present disclosure, the first adapter terminals 201a1 are insert-molded with the first insulating retention block 201a2. The second adapter terminals 201b1 are insert-molded with the second insulating retention block 201b2. The first insulating retention block 201a2 and the second insulating retention block 201b2 are provided with a protrusion 201b21 and a groove 201a21 that are cooperating with each other, so that the first adapter terminal module 201a and the second adapter terminal module 201b can be assembled together. In the illustrated embodiment of the present disclosure, the groove 201a21 is provided on one of the first insulating retention blocks 201a2, and the protrusion 201b21 is provided on one of the second insulating retention blocks 201b2.

In the illustrated embodiment of the present disclosure, the first mounting tail portions 201a15 of all the first adapter terminals 201a1 on the first adapter terminal module 201a are arranged in a staggered manner along the first direction A1-A1, and arranged in two rows. Similarly, the second mounting tail portions 201b15 of all the second adapter terminals 201b1 on the second adapter terminal module 201b are arranged in a staggered manner along the first direction A1-A1, and arranged in two rows. Part of the first mounting tail portions 201a15 are arranged in aligned with part of the second mounting tail portions 201b15 in the first direction A1-A1 to be pressed into the corresponding first conductive holes 404 of the circuit board 400, thereby achieving electrical connection with the circuit board 400. Another part of the first mounting tail portions 201a15 are arranged in aligned with another part of the second mounting tail portions 201b15 in the first direction A1-A1 to be pressed into the corresponding second conductive holes 405 of the circuit board 400, thereby achieving electrical connection with the circuit board 400.

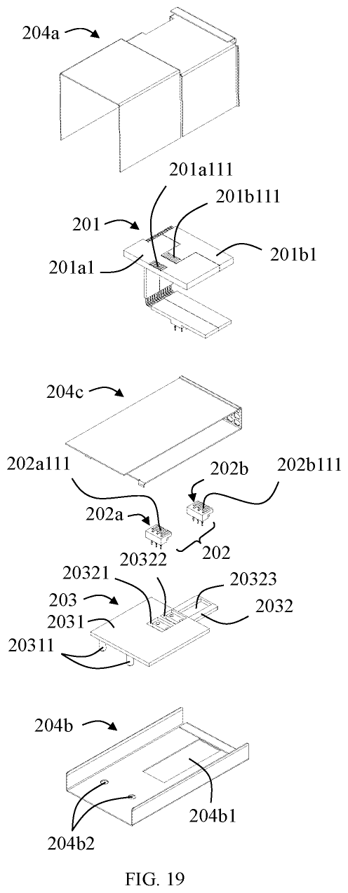

Referring to FIG. 19 to FIG. 23, in the illustrated embodiment of the present disclosure, the second adapter block 202 includes a third adapter terminal block 202a and a fourth adapter terminal block 202b. The third adapter terminal block 202a includes a plurality of third adapter terminals 202a1 and a third insulating retention block 202a2 fixed to the third adapter terminals 202a1. Each third adapter terminal 202a1 includes a third extension arm portion 202a11 extending in the first direction A1-A1, and a third mounting tail portion 202a12 extending in the second direction A2-A2. The third extension arm portion 202a11 is provided with a third contact surface 202a111 in a flat shape. The third contact surface 202a111 is exposed to the third insulating retention block 202a2. The third mounting tail portions 202a12 are arranged in two rows along the first direction A1-A1. Each third mounting tail portion 202a12 defines a third fish-eye hole 202a121 so that the third mounting tail portions 201a12 have a certain elastic deformation capability to facilitate being pressed into the corresponding third conductive holes 406 of the circuit board 400. In one embodiment of the present disclosure, the third adapter terminals 202a1 are insert-molded with the third insulating retention block 202a2.

Referring to FIG. 19 to FIG. 23, in the illustrated embodiment of the present disclosure, the fourth adapter terminal block 202b includes a plurality of fourth adapter terminals 202b1, and a fourth insulating retention block 202b2 fixed to the fourth adapter terminals 202b1. Each fourth adapter terminal 202b1 includes a fourth extension arm portion 202b11 extending in the first direction A1-A1, and a fourth mounting tail portion 202b12 extending in the second direction A2-A2. The fourth extension arm portion 202b11 is provided with a fourth contact surface 202b111 in a flat shape. The fourth contact surface 202b111 is exposed to the fourth insulating retention block 202b2. The fourth mounting tail portions 202b12 are arranged in two rows along the first direction A1-A1. Each fourth mounting tail portion 202b12 defines a fourth fish-eye hole 202b121, so that the fourth mounting tail portions 202b12 have a certain elastic deformation capability to facilitate being pressed into the fourth conductive holes 407 of the circuit board 400. In one embodiment of the present disclosure, the fourth adapter terminals 202b1 are insert-molded with the fourth insulating retention block 202b2.

The support block 203 is provided with a base portion 2031, and a protruding portion 2032 connected to the base portion 2031 and protruding downwardly beyond the base portion 2031. The protruding portion 2032 defines a first mounting groove 20321 for mounting the third adapter terminal block 202a, and a second mounting groove 20322 for mounting the fourth adapter terminal block 202b. The base portion 2031 is provided with a plurality of mounting posts 20311. The third insulating retention block 202a2 is engaged in the first mounting groove 20321. The fourth insulating retention block 202b2 is engaged in the second mounting groove 20322. The mounting posts 20311 are used to be inserted into the mounting positioning holes 403 of the circuit board 400. The protruding portion 2032 defines a through slot 20323 extending through the protruding portion 2032 in the second direction A2-A2. The first mounting tail portions 201a15 and the second mounting tail portions 201b15 extend downwardly through the through slot 20323 in the second direction A2-A2 for being mounted to the circuit board 400.

The support shell 204 includes a first shell portion 204a, a second shell portion 204b cooperating with the first shell portion 204a, and a partition portion 204c. The first shell portion 204a and the second shell portion 204b form a rectangular second space. The partition portion 204c divides the second space into a second receiving cavity 2042 located below the partition portion 204c. The second receiving cavity 2042 is in communication with the second accommodating cavity 501b.

The second shell portion 204b defines a mounting slot 204b1 extending through the second shell portion 204b along the second direction A2-A2, and a plurality of mounting through holes 204b2 extending through the second shell portion 204b along the second direction A2-A2. The protruding portion 2032 is engaged in the mounting slot 204b1. The mounting posts 20311 pass through the mounting through holes 204b2, and extend out of the shielding cage 500. The mounting posts 20311 are configured to be installed in the mounting positioning holes 403 of the circuit board 400.

The partition portion 204c defines a second locking hole 204c1 exposed in the second receiving cavity 2042. The second receiving cavity 2042 is used to accommodate the second electrical connector 100b. The locking protrusion 8121 of the second electrical connector 100b is locked in the second locking hole 204c1 to install and fix the second electrical connector 100b in the shielding cage 500.

It is understandable to those of ordinary skill in the art that in the illustrated embodiment of the present disclosure, the first adapter block 201, the second adapter block 202, the support block 203, and the support shell 204 are assembled to form the adapter module 200. Then, the adapter module 200 is installed in the shielding cage 500. At this time, a first receiving cavity 2041 is formed between the first wall portion 50a1 of the shielding cage 500 and the first shell portion 204a in the second direction A2-A2. The first receiving cavity 2041 is located between the second wall portion 50a2 and the third wall portion 50a3 in the third direction A3-A3. The first contact surface 201a111 of the first adapter terminal 201a1 and the second contact surface 201b111 of the second adapter terminal 201b1 are both exposed upwardly in the first receiving cavity 2041. When the first electrical connector 100a is inserted forwardly into the first receiving cavity 2041 from a rear end of the shielding cage 500 along the first direction A1-A1, the first elastic abutting portions 351 of the first board-end terminals 35 and the second elastic abutting portions 361 of the second board-end terminals 36 of the first electrical connector 100a elastically abut against the first contact surfaces 201a111 of the first adapter terminals 201a1 and the second contact surfaces 201b111 of the second adapter terminals 201b1, respectively. The locking protrusion 8121 of the first electrical connector 100a is locked in the first locking hole 50e1 to install and fix the first electrical connector 100 a in the shielding cage 500.

Similarly, when the second electrical connector 100b is inserted forwardly into the second receiving cavity 2042 from the rear end of the shielding cage 500 along the first direction A1-A1, the first elastic contact portions 351 of the first board-end terminals 35 of the second electrical connector 100b and the second elastic contact portions 361 of the second board-end terminals 36 of the second electrical connector 100b elastically abut against the third contact surfaces 202a111 of the third adapter terminals 202a1 and the fourth contact surfaces 202b111 of the fourth adapter terminals 202b111, respectively. The locking protrusion 8121 of the second electrical connector 100b is locked in the second locking hole 204c1 to install and fix the second electrical connector 100b in the shielding cage 500.

When the adapter module 200 and the shielding cage 500 are installed to the circuit board 400 as a whole, the first board-end terminals 35 and the second board-end terminals 36 of the second electrical connector 100b are finally electrically connected to the circuit board 400 by the adapter of the first adapter terminals 201a1, the second adapter terminals 201b1, the third adapter terminals 202a1 and the fourth adapter terminals 202b1.

Compared with the prior art, the electrical connector 100 of the present disclosure includes hybrid terminals. That is, part of the terminals are connected to the cables, and another part of the terminals are, directly or indirectly, connected to the circuit board 400. For the stacked ports (corresponding to the first accommodating cavity 501a and the second accommodating cavity 501b) in the illustrated embodiment of the present disclosure, the circuit board 400 may still be installed on one side of the stacked ports, rather than between them. The advantages of this arrangement include that, firstly, it facilitates the installation of the customer; and secondly, the electrical connector 100 can be plugged in after the customer has installed the adapter module 200 and the shielding cage 500 to the circuit board 400, thereby greatly improving the convenience of the customer's installation. Furthermore, it is avoided that the customer may cause the inconvenience when the adapter module 200 and the shielding cage 500 are installed to the circuit board 400 as a whole due to the electrical connector 100 itself.

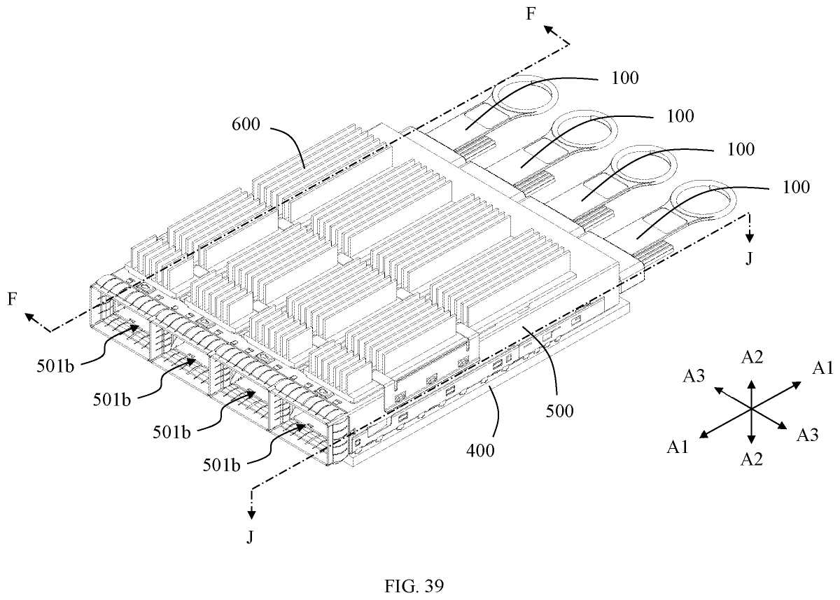

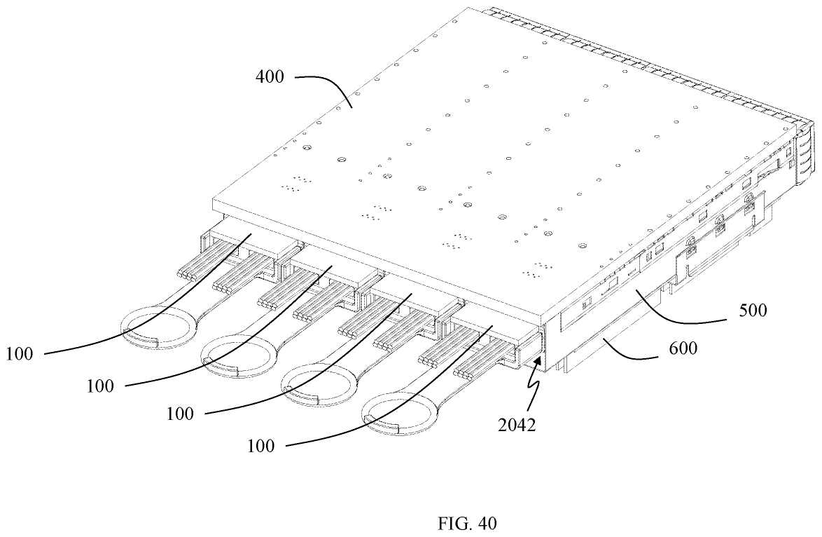

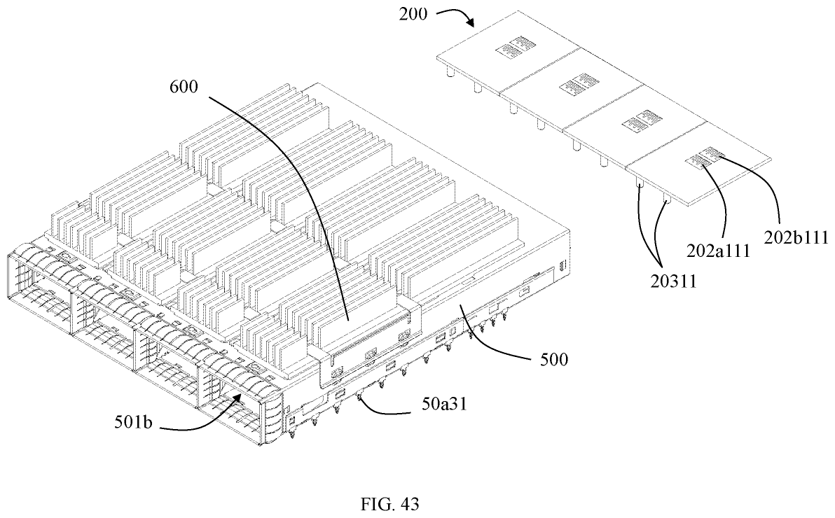

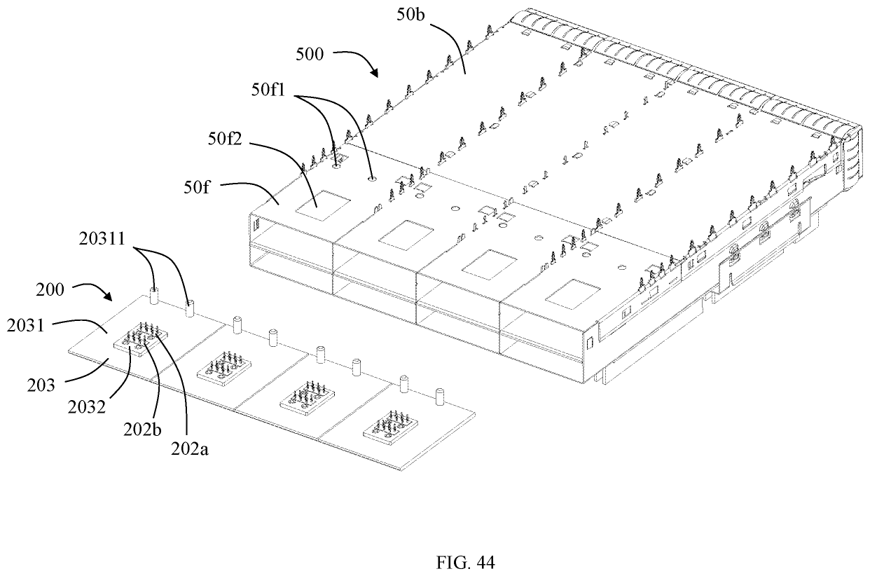

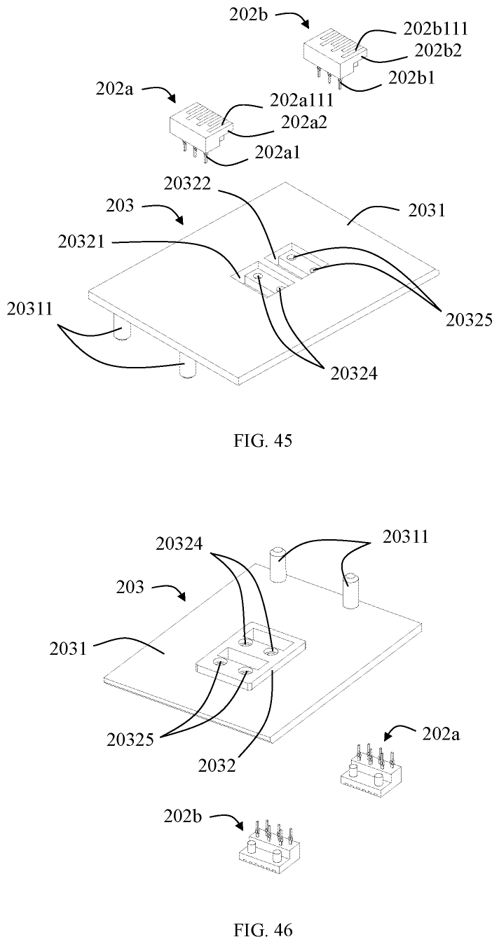

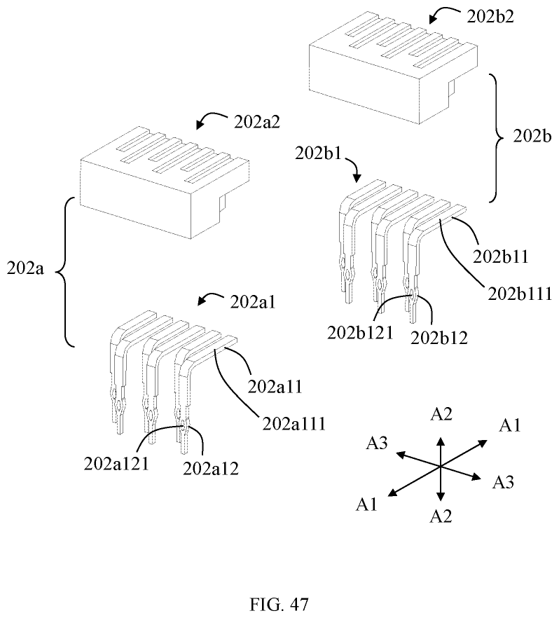

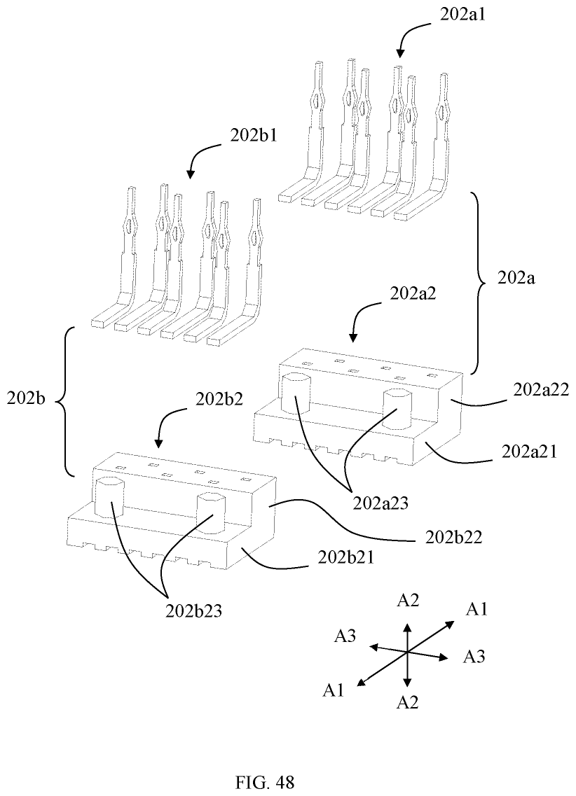

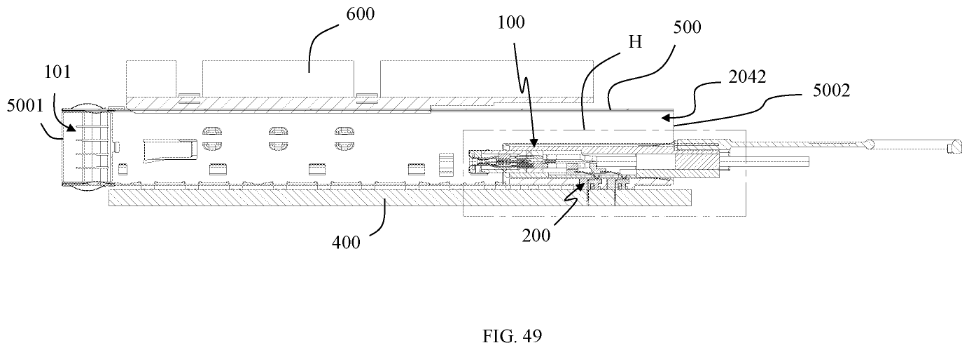

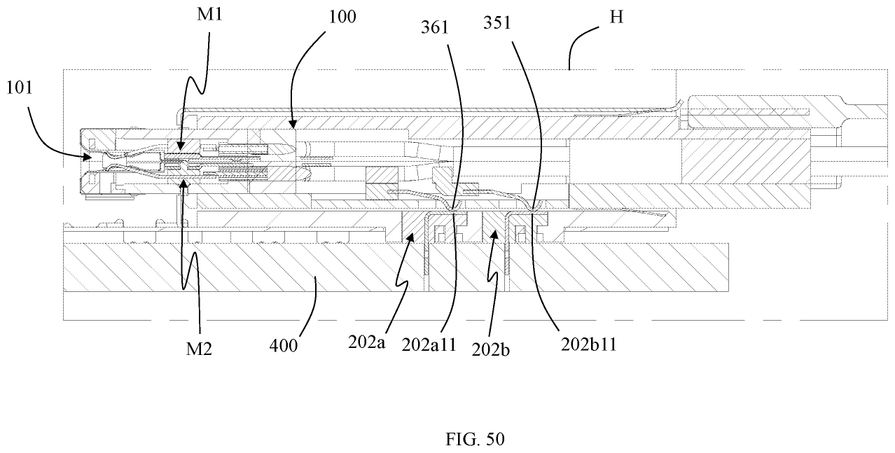

Referring to FIG. 39 to FIG. 50, in yet another embodiment of the present disclosure, the connector assembly includes a plurality of electrical connectors 100, a plurality of adapter modules 200 cooperating with the electrical connectors 100, a shielding cage 500 enclosing a periphery of the adapter modules 200, a plurality of heat sinks 600 attached to the shielding cage 500, a circuit board 400, and a plurality of mating connectors 300 for at least partially being inserted into the electrical connectors 100. In the illustrated embodiment of the present disclosure, the shielding cage 500 is configured to be mounted to the circuit board 400. The adapter modules 200 are installed in the shielding cage 500. Each adapter module 200 includes a second adapter module 202 and a support block 203. In the illustrated embodiment of the present disclosure, the connector assembly is a single layer assembly with 1*4 ports in architecture. The connector assembly defines four second accommodating cavities 501b arranged at intervals along the third direction A3-A3, and four second receiving cavities 2042 in communication with the second accommodating cavities 501b, respectively. Accordingly, four electrical connectors 100, four adapter modules 200, and four mating connectors 300 are provided. The shielding cage 500 includes a first end face 5001 (for example, a front end face), and a second end face 5002 (for example, a rear end face) disposed opposite to the first end face 5001. The second accommodating cavities 501b extend through the first end surface 5001 to one side (for example, forwardly) along the first direction A1-A1. The second receiving cavities 2042 extend through the second end face 5002 to another side (for example, backwardly) along the first direction A1-A1.

Corresponding to one second accommodating cavity 501b, the shielding cage 500 includes a first shielding shell 50a, a second shielding shell 50b cooperating with the first shielding shell 50a, and a third shielding shell 50f cooperating with the first shielding shell 50a.

The first shielding shell 50a includes a first wall portion 50a1 (for example, a top wall), a second wall portion 50a2 (for example, a left side wall), and a third wall portion 50a3 (for example, a right side wall). The second wall portion 50a2 includes a plurality of first press-fit pins 50a21 extending in the second direction A2-A2. Each first press-fit pin 50a21 defines a first through hole so that the first press-fit pins 50a21 have a certain elastic deformation capability to facilitate being pressed into the first mounting holes 401 of the circuit board 400. The third wall portion 50a3 includes a plurality of second press-fit pins 50a31 extending in the second direction A2-A2. Each second press-fit pin 50a31 defines a second through hole so that the second press-fit pins 50a31 have a certain elastic deformation capability to facilitate being pressed into the second mounting holes 402 of the circuit board 400.

The third shielding shell 50f defines a plurality of first mounting through holes 50f1, and an opening 50f2. The first shielding shell 50a is hooked together with the second shielding shell 50b and the third shielding shell 50f to form the second accommodating cavity 501b of a generally rectangular-shaped configuration. The first press-fit pins 50a21 extend downwardly through the second shielding shell 50b and the third shielding shell 50f, and the second press-fit pins 50a31 extend downwardly through the second shielding shell 50b and the third shielding shell 50f for easily being mounted to the circuit board 400.

In the illustrated embodiment of the present disclosure, the second adapter module 202 includes a third adapter terminal module 202a and a fourth adapter terminal module 202b. The third adapter terminal module 202a includes a plurality of third adapter terminals 202a1, and a third insulating retention block 202a2 fixed to the third adapter terminals 202a1. Each third adapter terminal 202a1 includes a third extension arm portion 202a11 extending in the first direction A1-A1, and a third mounting tail portion 202a12 extending in the second direction A2-A2. The third extension arm portion 202a11 is provided with a third contact surface 202a111 in a flat shape. The third contact surfaces 202a111 are exposed to the third insulating retention block 202a2. The third mounting tail portions 202a12 are arranged in two rows along the first direction A1-A1. Each third mounting tail portion 202a12 defines a third fish-eye hole 202a121 so that the third mounting tail portions 201a12 have a certain elastic deformation capability to facilitate being pressed into the corresponding third conductive holes 406 of the circuit board 400. In one embodiment of the present disclosure, the third adapter terminals 202a1 are insert-molded with the third insulating retention block 202a2. In the illustrated embodiment of the present disclosure, the third insulating retention block 202a2 is provided with a first body portion 202a21, a second body portion 202a22 connected to the first body portion 202a21 and protruding beyond the first body portion 202a21 along the second direction A2-A2, and a plurality of first positioning posts 202a23 connected to the first body portion 202a21 and protruding beyond the first body portion 202a21 along the second direction A2-A2. The first positioning posts 202a23 are located on one side of the second body portion 202a22 in the first direction A1-A1. The first body portion 202a21 and the second body portion 202a22 are of a step-shaped configuration.

Similarly, in the illustrated embodiment of the present disclosure, the fourth adapter terminal module 202b includes a plurality of fourth adapter terminals 202b1, and a fourth insulating retention block 202b2 fixed to the fourth adapter terminals 202b1. Each fourth adapter terminal 202b1 includes a fourth extension arm portion 202b11 extending in the first direction A1-A1, and a fourth mounting tail portion 202b12 extending in the second direction A2-A2. The fourth extension arm portion 202b11 is provided with a fourth contact surface 202b111 in a flat shape. The fourth contact surfaces 202b111 are exposed to the fourth insulating retention block 202b2. The fourth mounting tail portions 202b12 are arranged in two rows along the first direction A1-A1. Each fourth mounting tail portion 202b12 defines a fourth fish-eye hole 202b121, so that the fourth mounting tail portions 202b12 have a certain elastic deformation capability to facilitate being pressed into the fourth conductive holes 407 of the circuit board 400. In one embodiment of the present disclosure, the fourth adapter terminals 202b1 are insert-molded with the fourth insulating retention block 202b2. In the illustrated embodiment of the present disclosure, the fourth insulating retention block 202b2 is provided with a third body portion 202b21, a fourth body portion 202b22 connected to the third body portion 202b21 and protruding beyond the third body portion 202b21 along the second direction A2-A2, and a plurality of second positioning posts 202b23 connected to the third body portion 202b21 and protruding beyond the third body portion 202b21 along the second direction A2-A2. The second positioning posts 202b23 are located on one side of the fourth body portion 202b22 in the first direction A1-A1. The third body portion 202b21 and the fourth body portion 202b22 are of a step-shaped configuration.

The support block 203 includes a base portion 2031, and a protruding portion 2032 connected to the base portion 2031 and protruding downwardly beyond the base portion 2031. The support block 203 defines a first mounting groove 20321 for mounting the third adapter terminal module 202a, a second mounting groove 20322 for mounting the fourth adapter terminal module 202b, a plurality of first positioning holes 20324 located in the first mounting groove 20321, and a plurality of second positioning holes 20325 located in the second mounting groove 20322. The first mounting groove 20321 and the second mounting groove 20322 correspond to a position where the protruding portion 2032 is located, and are at least partially extend through the protruding portion 2032 in the second direction A2-A2. The third insulating retention block 202a2 is engaged in the first mounting groove 20321. The fourth insulating retention block 202b2 is engaged in the second mounting groove 20322. The first positioning posts 202a23 are fixed in the first positioning holes 20324. The second positioning posts 202b23 are fixed in the second positioning holes 20325. Besides, the base portion 2031 is provided with a plurality of mounting posts 20311. The mounting posts 20311 pass through the first mounting through holes 50f1 for being inserted into the mounting positioning holes 403 of the circuit board 400. The protruding portion 2032 is received in the opening 50f2 and protrudes downwardly beyond the third shielding shell 50f.

Each heat sink 600 protrudes at least partially into the second accommodating cavity 501b to be in contact with a corresponding mating connector 300 for heat dissipation.

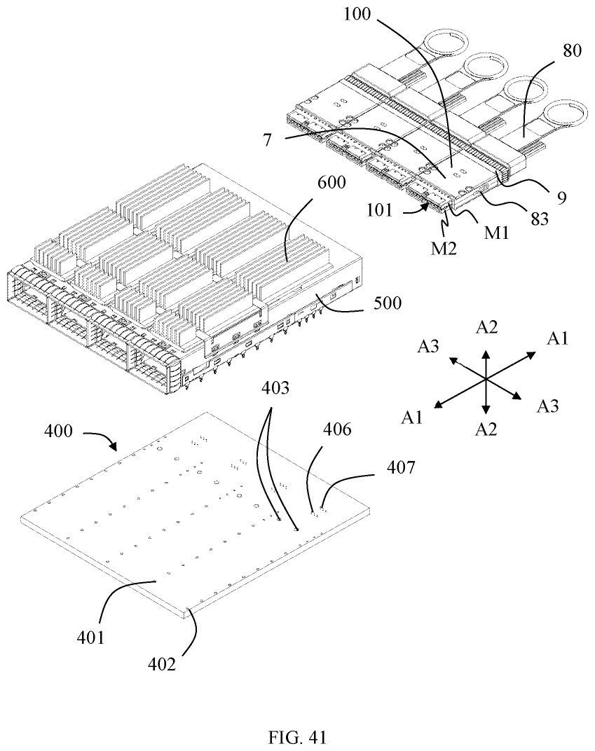

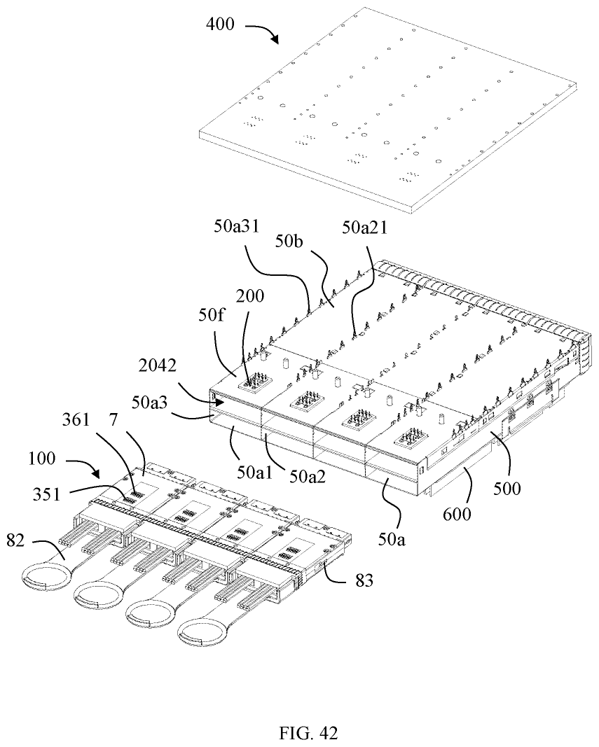

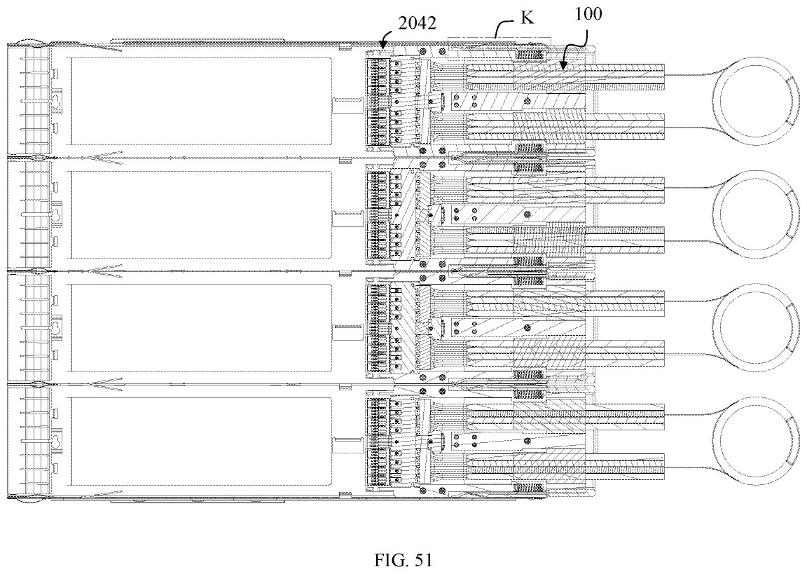

The electrical connector 100 shown in FIG. 41 and FIG. 42 are similar to the electrical connector 100 shown in FIG. 24 to FIG. 35, in which the main difference therebetween is that the electrical connector 100 shown in FIG. 41 and FIG. 42 includes an unlocking device 80. The unlocking device 80 includes an unlocking elastic arm 83, a pull strap 82 connected to the unlocking elastic arm 83, and at least one elastic component 84 abutting against the unlocking elastic arm 83. In the illustrated embodiment of the present disclosure, the elastic component 84 is a compression spring. The unlocking elastic arm 83 is located at least one side of the electrical connector 100. Referring to FIG. 51 to FIG. 53, in the illustrated embodiment of the present disclosure, two unlocking elastic arms 83 are provided, and located on two sides of the electrical connector 100, respectively. The shielding cage 500 is provided with a spring tab 5003 protruding into the second receiving cavity 2042, and configured to lock with the electrical connector 100 to retain the electrical connector 100 in the second receiving cavity 2042. The unlocking elastic arm 83 is provided with an arcuate surface 831. Besides, the structure of the pull strap 82 of the electrical connector 100 shown in FIG. 41 and FIG. 42 is also different from the pull strap 82 of the electrical connector 100 shown in FIG. 24 to FIG. 35.

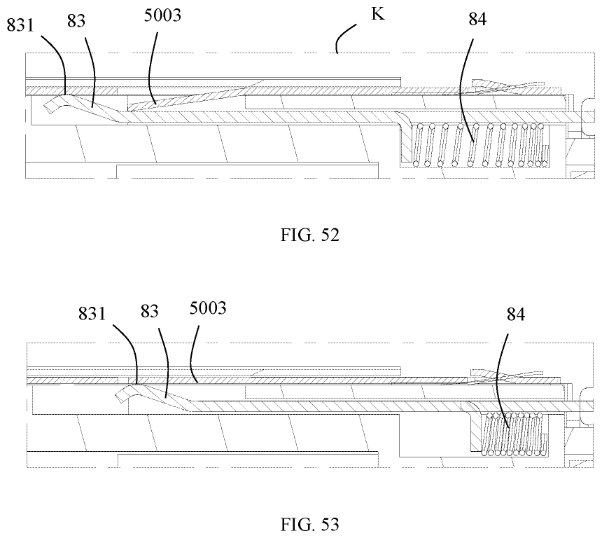

Referring to FIG. 52 and FIG. 53, when unlocking, a rearward pulling force is applied to the pull strap 82. At this time, the unlocking elastic arm 83 moves backwardly under the action of the pull strap 82. The arcuate surface 831 of the unlocking elastic arm 83 press against the spring tab 5003 outward to release the spring tab 5003 from a locked position to realize unlocking.

The electrical connector 100 shown in FIG. 41 and FIG. 42 also includes a first module M1, a second module M2, an outer insulating housing 7 fixed to the first module M1 and the second module M2, and an elastic sleeve 9 sleeved on the outer insulating housing 7. The first module M1, the second module M2, and the elastic sleeve 9 shown in FIG. 41 and FIG. 42 are similar to the first module M1, the second module M2, and the elastic sleeve 9 shown in FIG. 24 to FIG. 35, respectively, which will not be repeated here in the present disclosure.

It is understandable to those skilled in the art that in the illustrated embodiment of the present disclosure, the second adapter module 202 and the support block 203 are assembled together to form the adapter module 200. Then, the adapter module 200 is installed in the shielding cage 500. The third contact surfaces 202a111 of the third adapter terminals 202a11 and the fourth contact surfaces 202b111 of the fourth adapter terminals 202b111 are exposed upwardly in the second receiving cavity 2042. When the electrical connector 100 is inserted forwardly into the second receiving cavity 2042 from a rear end of the shielding cage 500 in the first direction A1-A1, the first elastic contact portions 351 of the first board-end terminals 35 and the second elastic contact portions 361 of the second board-end terminals 36 of the electrical connector 100 are elastically contacted with the third contact surfaces 202a111 of the third adapter terminals 202a1 and the fourth contact surfaces 202b111 of the fourth adapter terminals 202b1, respectively.

When the adapter module 200 and the shielding cage 500 are mounted to the circuit board 400 as a whole, the first board-end terminals 35 and the second board-end terminals 36 of the electrical connector 100 finally realize electrical connection with the circuit board 400.

Compared with the prior art, the electrical connector 100 of the present disclosure includes hybrid terminals. That is, part of the terminals are connected to the cables, and another part of the terminals are connected to the circuit board 400, directly or indirectly. The advantages of this arrangement method include that, firstly, it facilitates the installation of the customer; and secondly, the electrical connector 100 can be plugged in after the customer has installed the adapter module 200 and the shielding cage 500 on the circuit board 400, thereby greatly improving the convenience of the customer's installation, and avoiding inconvenience when the customer installs the adapter module 200 and the shielding cage 500 on the circuit board 400 due to the electrical connector 100 itself.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector, comprising:
a shielding cage, the shielding cage comprising a first end face, a second end face disposed opposite to the first end face, an accommodating cavity extending through the first end face along a first direction, and a receiving cavity extending through the second end face along the first direction; the accommodating cavity being configured to accommodate a mating connector along the first direction; the receiving cavity is configured to accommodate an electrical connector along the first direction; the electrical connector being configured to mate with the mating connector; and
an adapter module, the adapter module being at least partially disposed in the shielding cage; the adapter module comprising an adapter block, the adapter block comprising a plurality of adapter terminals and an insulating retention block fixed with the adapter terminals; each adapter terminal comprising a contact surface exposed from the insulating retention block and located in the receiving cavity, and a mounting tail configured to be electrically connected to a circuit board.

2. The connector according to claim 1, wherein the contact surface is configured to elastically abut against a board-end terminal of the electrical connector.

3. The connector according to claim 1, wherein the accommodating cavity comprises a first accommodating cavity and a second accommodating cavity; the first accommodating cavity and the second accommodating cavity are stacked along a second direction; and the second direction is perpendicular to the first direction.

4. The connector according to claim 3, wherein the receiving cavity comprises a first receiving cavity and a second receiving cavity; the first receiving cavity is in communication with the first accommodating cavity; and the second receiving cavity is in communication with the second accommodating cavity;
the adapter module comprises a first adapter block, the first adapter block comprising a first adapter terminal module and a second adapter terminal module;
the first adapter terminal module comprises a plurality of first adapter terminals and a first insulating retention block fixed with the first adapter terminals; each first adapter terminal comprises a first contact surface exposed from the first insulating retention block and located in the first receiving cavity, and a first mounting tail portion configured to be electrically connected to the circuit board;
the second adapter terminal module comprises a plurality of second adapter terminals and a second insulating retention block fixed with the second adapter terminals; each second adapter terminal comprises a second contact surface exposed from the second insulating retention block and located in the first receiving cavity, and a second mounting tail portion configured to be electrically connected to the circuit board;
wherein the adapter submodule comprises the first adapter block; the adapter terminals comprise the first adapter terminals and the second adapter terminals; the insulating retention block comprises the first insulating retention block and the second insulating retention block; the contact surfaces comprise the first contact surfaces and the second contact surfaces; the mounting tails comprise the first mounting tails and the second mounting tails.

5. The connector according to claim 1, wherein the adapter module comprises a second adapter block, the second adapter block comprises a third adapter terminal module; the third adapter terminal module comprises a plurality of third adapter terminals and a third insulating retention block fixed with the third adapter terminals; each third adapter terminal comprises a third contact surface exposed from the third insulating retention block and located in the receiving cavity, and a third mounting tail portion configured to be electrically connected to the circuit board.

6. The connector according to claim 5, wherein each third adapter terminal comprises a third extension arm portion extending along the first direction, and a third mounting tail portion extending along a second direction; the third contact surface is provided on the third extension arm portion; and the third mounting tail portion defines a third fish-eye hole.

7. The connector according to claim 5, wherein the third adapter terminals are insert-molded with the third insulating retention block.

8. The connector according to claim 5, wherein the adapter module comprises a support block, and the support block defines a first mounting groove in which the third adapter terminal module is installed.

9. The connector according to claim 8, wherein the support block defines a first positioning hole located in the first mounting groove;
the third insulating retention block comprises a first positioning post, and the first positioning post is inserted in the first positioning hole.

10. The connector according to claim 8, wherein the support block comprises a mounting post; the shielding cage defines a first mounting through hole; the mounting post extends out of the shielding cage through the first mounting through hole; and the mounting post is configured to be inserted in a mounting positioning hole of the circuit board.

11. The connector according to claim 8, wherein the support block comprises a protruding portion; the shielding cage defines an opening; and the protruding portion is received in the opening.

12. The connector according to claim 11, wherein the third mounting tail portion extends out of the protruding portion.

13. The connector according to claim 5, wherein the second adapter block comprises a fourth adapter terminal module; the fourth adapter terminal module comprises a plurality of fourth adapter terminals and a fourth insulating retention block fixed with the fourth adapter terminals; each fourth adapter terminal comprises a fourth contact surface exposed from the fourth insulating retention block and located in the receiving cavity, and a fourth mounting tail portion configured to be electrically connected to the circuit board.

14. A connector assembly, comprising:
a connector comprising:
a shielding cage, the shielding cage comprising a first end face, a second end face disposed opposite to the first end face, an accommodating cavity extending through the first end face along a first direction, and a receiving cavity extending through the second end face along the first direction; the accommodating cavity being configured to accommodate a mating connector along the first direction; and
an adapter module, the adapter module being at least partially disposed in the shielding cage; the adapter module comprising an adapter block, the adapter block comprising a plurality of adapter terminals and an insulating retention block fixed with the adapter terminals; each adapter terminal comprising a contact surface exposed from the insulating retention block and located in the receiving cavity, and a mounting tail configured to be electrically connected to a circuit board; and
an electrical connector, the receiving cavity being configured to accommodate the electrical connector along the first direction; the electrical connector being configured to mate with the mating connector; the electrical connector comprising a plurality of conductive terminals, a cable electrically connected to the conductive terminals, and a plurality of board-end terminals; each board-end terminal comprising an elastic contact portion;
wherein the electrical connector is at least partially inserted in the receiving cavity along the first direction, such that the elastic contact portions abut against the contact surfaces.

15. The connector assembly according to claim 14, wherein the electrical connector comprises a first module and a second module;
the first module comprises a first conductive shell; the conductive terminals comprise a plurality of first conductive terminals partially disposed in the first conductive shell; the board-end terminals comprise a plurality of first board-end terminals partially disposed in the first conductive shell; the cable comprises a first cable electrically connected to the first conductive terminals; each first conductive terminals comprises a first contact portion; the first board-end terminals comprise a plurality of first additional contact portions; and at least some of the first board-end terminals further comprise a plurality of first elastic contact portions;
the second module comprises a second conductive shell; the conductive terminals comprise a plurality of second conductive terminals partially disposed in the second conductive shell; the board-end terminals comprise a plurality of second board-end terminals partially disposed in the second conductive shell; the cable comprises a second cable electrically connected to the second conductive terminals; each second conductive terminal comprises a second contact portion; the second board-end terminals comprise a plurality of second additional contact portions; at least some of the second board-end terminals further comprise a plurality of second elastic contact portions; and the elastic contact portions comprise the first elastic contact portions and the second elastic contact portions;
wherein the first conductive shell and the second conductive shell jointly form a receiving slot; the receiving slot is in communication with the accommodating cavity; and the first contact portions, the first additional contact portions, the second contact portions and the second additional contact portions all protrude into the receiving slot.

16. The connector assembly according to claim 15, wherein the electrical connector comprises an outer insulating housing fixed to the first module and the second module; the outer insulating housing comprises a first outer insulating housing and a second outer insulating housing; the first module and the second module are clamped between the first outer insulating housing and the second outer insulating housing; the outer insulating housing defines a plurality of first slots and a plurality of second slots; the first elastic contact portions of the first board-end terminals and the second elastic contact portions of the second board-end terminals extend through the first slots and the second slots, respectively, so as to protrude out of the outer insulating housing.

17. The connector assembly according to claim 16, wherein the electrical connector comprises an elastic sleeve sleeved over the outer insulating housing, and the elastic sleeve comprises a plurality of cantilevered abutting arms.

18. The connector assembly according to claim 14, wherein the shielding cage of the connector comprises a spring tab protruding into the receiving cavity, and the spring tab is configured to lock with the electrical connector;
the electrical connector comprises an unlocking device; the unlocking device comprises an unlocking arm and a pull strap connected to the unlocking arm; the unlocking arm is configured to be pulled by the pull strap to move; and the unlocking arm presses against the spring tab outward during movement in order to release the spring tab from the electrical connector.

19. The connector assembly according to claim 18, wherein the unlocking arm comprises an arcuate surface configured to engage with the spring tab.

20. The connector assembly according to claim 14, wherein the contact surface is configured to elastically abut against a board-end terminal of the electrical connector.
